(19) United States
(12) Patent Application Publication
(10) Pub. No.: US 2024/0206023 A1
(43) Pub. Date: Jun. 20, 2024

(54) INDUCTIVE HEATING ADAPTER SYSTEM AND METHOD

(71) Applicant: Channing Street Copper Company, Berkeley, CA (US)

(72) Inventors: Samuel Eli Calisch, Oakland, CA (US); Tucker Gilman, Oakland, CA (US); Pushan Panda, San Francisco, CA (US); Miles Smith, San Francisco, CA (US); Eric Wilhelm, Oakland, CA (US)

(21) Appl. No.: 18/545,522

(22) Filed: Dec. 19, 2023

Related U.S. Application Data
(60) Provisional application No. 63/476,306, filed on Dec. 20, 2022.

(51) Int. Cl. H05B 6/12; F24C 7/06; H05B 6/44

(52) U.S. Cl. CPC H05B 6/1227; F24C 7/067; H05B 6/1236; H05B 6/44; H05B 2206/022

(57) ABSTRACT

An inductive heating adapter comprising a base portion that includes a planar first coil and a planar second coil. The inductive heating adapter further comprises an adapter portion that defines a curved cavity and includes a curved third coil that corresponds to the curved cavity, the adapter portion configured to hold a curved vessel within the curved cavity defined by the adapter portion. The inductive heating adapter further comprises an electrical connection between the base portion and the adapter portion. The base portion is configured to be disposed on a burner area of a stove top of an inductive stove with the curved vessel disposed within the curved cavity and the burner area of the inductive stove comprises a stove coil configured to wirelessly generate an electrical current in the base portion that causes inductive heating of the curved vessel disposed within the curved cavity.

### CROSS-REFERENCE TO RELATED APPLICATIONS

This application is a non-provisional of and claims the benefit of U.S. Provisional Application No. 63/476,306, filed Dec. 20, 2022, entitled “SYSTEM AND METHOD FOR A WIRELESS POWER TRANSMISSION INDUCTIVE HEATING ADAPTER,” with attorney docket number COPP-M02-PRV. This application is hereby incorporated herein by reference in its entirety and for all purposes.

This application is also related to U.S. patent application Ser. No. 17/692,714, filed Mar. 11, 2022, entitled “APPLIANCE LEVEL BATTERY-BASED ENERGY STORAGE,” which application is hereby incorporated herein by reference in its entirety and for all purposes.

### BRIEF DESCRIPTION OF THE DRAWINGS

FIG. 1 illustrates an example of a powered building system that comprises a building, which can obtain electrical power from various suitable sources such as an electrical grid, one or more solar panels, and/or battery systems.

FIG. 2 illustrates examples of load sources that can be associated with a powered building system in an embodiment.

FIG. 3a illustrates an example of a stove load source that comprises a battery system that can be an internal component of the stove, an integral component of the stove, disposed within a housing of the stove, or the like.

FIG. 3b illustrates another example embodiment of a battery system that can be part of a power distribution system and can be disposed on and/or in a wall of a building and can comprise a receptacle and battery that are configured to receive electrical power from a power line.

FIG. 3c illustrates another example embodiment of a battery system having a battery and a power cord with a plug, where the battery system can be a unit disposed between the stove load source and a receptacle that is part of a power distribution system.

FIG. 4 illustrates one example embodiment of a battery system that can comprise one or more batteries, a processor, a memory, a clock, a battery control system, a communication system, an interface and an electrical power bus.

FIG. 5 illustrates an example embodiment of a battery network that comprises three battery systems, a battery server and a user device, which are operably connected via a network.

FIG. 6 illustrates an example embodiment of an inductive heating adapter that comprises a base portion and an adapter portion that are electrically coupled via a connection.

FIG. 7 illustrates an embodiment of an inductive heating adapter with a base portion that comprises a first unit and a separate second unit, where the first unit comprises a first coil and a first ferrite and the second unit comprises and a second coil and a second ferrite.

FIG. 8 illustrates a side-cutaway view of an inductive heating adapter.

FIG. 9 illustrates an electrical schematic of one example embodiment of an inductive heating adapter.

FIG. 10 illustrates an electrical schematic of another example embodiment of an inductive heating adapter comprising a matching capacitor and inductor for matching impedance.

FIG. 11 illustrates an inductive heating adapter comprising an extension coil electrically coupled to a first coil via one or more connections.

FIG. 12 illustrates an embodiment of an inductive heating adapter where a base portion is coupled with an adapter portion via a plurality of arms, which fixes the adapter portion over the base portion and where the inductive heating adapter comprises a fan.

FIG. 13a illustrates an example of a cooking vessel that comprises a completely and continuously curving base that includes a base minimum that is a point or small area with curved sidewalls extending therefrom.

FIG. 13b illustrates an example of a cooking vessel that comprises a partially curving base that includes a base minimum that is a planar area with curved sidewalls extending therefrom.

FIG. 13c illustrates an example of a cooking vessel that comprises a flat base that includes a base minimum that is a planar area with vertical sidewalls extending therefrom.

FIG. 14 illustrates an example where a base portion of an inductive heating adapter is configured to power to a plurality of adapter portions via respective couplings.

FIG. 15 illustrates an example embodiment of an inductive heating adapter that comprises a first and second base portion that are disposed on a respective first and second burner area on a stove top of a stove.

FIG. 16a illustrates an example embodiment where a base portion of an inductive heating adapter is electrically coupled to a load source via a connection.

FIG. 16b illustrates an inductive heating adapter that comprises an electrical plug.

FIG. 17 illustrates a method of using an embodiment of an inductive stove adapter.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Induction cooking can be performed using direct induction heating of a cooking vessel, rather than relying on indirect radiation, convection, or thermal radiation. Induction cooking in various examples allows high-power and rapid increases in temperature to be achieved, and changes in heat settings can be nearly instantaneous in various examples. Rapid and direct heating of cooking vessels can allow for precise control over cooking temperatures, making induction stoves a desirable choice for many professional and home cooks in various applications.

In various embodiments of an induction stove, a cooking vessel (e.g., made of ferromagnetic material) is placed on the stove surface, directly above an induction coil. This coil can be a type of electric transformer, with the cooking vessel acting as the secondary coil and the stove itself as the primary coil. When the stove is turned on, an alternating current is passed through the induction coil, creating a dynamic magnetic field. This magnetic field induces an electric eddy current that flows in a circular path within a thin layer of the base of the cooking vessel, encountering resistance as it does so. This resistance generates heat, which is then transferred to the food inside the vessel for cooking. The heat generation process can be highly efficient in various examples, as it occurs directly within the cooking vessel, reducing heat loss to the surrounding environment. Induction cooking in various examples can require sufficient electrical coupling between the cooking vessel and the stove for desirable operation. For example, in various embodiments, the base of the cooking vessel must be flat and in full contact with the stove surface to ensure maximum efficiency.

Creating suitable electrical coupling between a flat-bottomed cooking vessel and an induction coil in a stove top can be fairly simple in various embodiments, but can be more difficult for cooking vessels with different form factors such as a wok, bowl, tagine, kadai/karahi, balti dish, cazuela, yukihira nabe or peking pan, which may have a non-flat bottom and may instead be rounded, curved, or the like.

Additionally, in various embodiments, an inductive stove will only primarily heat the flat bottom of a cooking vessel that is proximate to the inductive coil of the stove. However, in some examples, it may be desirable to heat other portions of a cooking vessel such as the sidewalls of a pot, pan or pressure cooker (e.g., a saucepan, frying pan, skillet, sauté pan, stockpot, Dutch oven, grill pan, omelet pan, simmering pot, and the like).

Various embodiments discussed herein include a system and method for a wireless transmission inductive heating adapter that includes a set of coils configured to transfer inductive power from an inductive stove burner to a cooking vessel. Some embodiments include a set of one or more ferrites, positioned in proximity to the set of coils to improve inductive energy transfer between the set of coils. The set of coils can includes a burner coil (e.g., a flat coil that may be positioned on top of an inductive stove burner such that power can be transferred from the inductive stove to the burner coil); at least one intermediary coil configured to inductively receive energy from the burner coil; and a form factor coil that is electrically connected to the intermediary coil and having a distinct form factor (e.g., curved) to enable inductive energy transfer to a cooking vessel corresponding to the distinct form factor. Such a system and method in various embodiments can function to enable use of an inductive stove with cooking vessels that would not or could not be suitable for use with an inductive stove due to their shape. For example, such a system and method in some embodiments can enable use of an inductive stove to heat curved pots or pans (e.g., woks) that would typically not be possible or suitable on an inductive stove due to the curvature of the cooking vessel.

Also, while various example embodiments disclosed herein relate to cooking and cooking vessels, it should be clear that the systems and methods disclosed herein can be applicable to various suitable applications where material is heated in a vessel, including settings such as in laboratory work, manufacturing, engineering, art, or the like. For example, such activities can include soap making, candle making, dying fabric, manufacturing cosmetics, chemistry, encaustic art, jewelry making, distillation, heat treatment of metal, curing of ceramics or pottery, melting of thermoplastics, preparation of pharmaceutical compounds, polymerization reactions, and the like. Also, some embodiments can include flat cooking vessels such as a griddle, or the like.

Further embodiments include a system that pushes battery storage from centralized installations in the home out to the points of load (the “edges,” by analogy with edge computing). In such a distributed model of energy storage, appliances can be equipped with on-board batteries and can do the work of self-managing their demands on the home and utility grid. Some embodiments of a battery system can be built into the home itself. In various embodiments this can enable storage behind various suitable appliances or other load sources without integrating the battery into the appliance or load source itself. The battery device may be installed behind the wall plug itself, or in front of the plug as an intermediary between appliance and wall outlet.

Having multiple appliances with batteries throughout the home in various examples provides the ability for the batteries and appliances to communicate power usage to one another. For example, if Appliance One is fully charged, or close to fully charged, and it is desirable for Appliance Two to take up a portion of the electrical load by powering on, Appliance One can be queried to determine if that is possible without disrupting or overloading the circuit.

Induction stoves, refrigerators, hot water heaters, heat pumps and laundry machines are some examples of appliances that can be equipped with battery storage systems in some embodiments. Power tools can be equipped with such battery storage technology and battery management intelligence to balance how and when electricity is pulled from the grid. In some embodiments of a connected household where the batteries are connected behind the plug, this can be done down to a micro scale, optimizing the entire home's power usage.

Some embodiments can include an inductive heating adapter that comprises a base portion and an adapter portion that are electrically coupled via a connection such as a wire. The base portion can comprise a first coil and a second coil, which in some examples are disposed between a first ferrite and a second ferrite. The adapter portion can define a cavity and can comprise a third coil, and in some examples, can include a third ferrite.

An inductive heating adapter can be disposed on a burner area of a stove top of a stove with a cooking vessel disposed within the cavity defined by the adapter portion. The burner area of the stove can comprise a stove coil disposed below or within the stove top (e.g., below a glass panel). In various embodiments, the first coil and the second coil of the base portion can serve as intermediary wireless transformers to convey electrical power up to the adapter portion via a connection, which can in turn inductively heat the cooking vessel.

In various embodiments, the first coil can be planar and positioned in proximity to a stove coil of an inductive stove, such as on a glass or ceramic stove top at a burner area. In various embodiments, the second coil may be flat and positioned in proximity of the first coil such that the first coil induces a counteracting current in the second coil. The third coil can be electrically connected to the second coil which can drive current in the third coil. The third coil may be curved or have another specialized or desirable form factor geometry such that a curved pot, pan or wok may be set in sufficient proximity of the third coil to cause a counteracting current to be induced in such a cooking vessel to cause inductive heating and thereby allow for inductive cooking.

In various embodiments, one or more inductive heating adapters can be configured to receive and/or send electrical power within a powered building system as discussed below, including smart sharing, using and/or storing of electrical power among one or more other load sources, batteries, or the like.

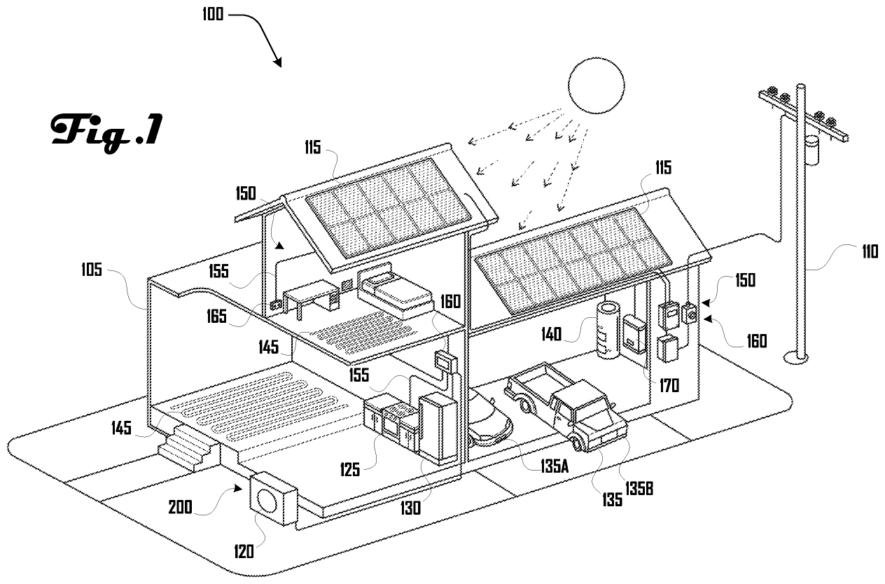

For example, FIG. 1 illustrates an example of a powered building system 100 that comprises a building 105, which can obtain electrical power from various suitable sources such as an electrical power grid 110, one or more solar panels 115, and the like. Such electrical power can power to various suitable load sources 200 (e.g., appliances, elements, systems, vehicles, and the like), such as a heat pump 120, electric stove 125, refrigerator 130, electric vehicles 135, water heater 140, electrical floor heating elements 145, and the like. Power can be distributed to or among such load sources 200 via an electric power distribution system 150 that can comprise power lines 155, electrical sub-elements 160 that provide power to electric receptacles 165, or the like.

One embodiment includes an inductive electric stove 125 that plugs into a standard 120 v plug/receptacle with no additional installation required. In some embodiments, such an inductive electric stove can operate from a 120 v, 15 A power source with an inductor output of 3200 W and with an auxiliary power output of 120 VAC, 60 Hz. In some embodiments, a stove 125 can comprise a 4 kWh Lithium Iron Phosphate (LiFePO4) battery that stores power received and is configured to fully or at least partially operate the stove 125 based on power from the battery. One embodiment of a stove 125 is 29⅞ inches wide, 28 15/16 inches deep, including handle, 37⅞ inches total height, 36 inches height to cooking surface, with adjustable feet that can add up to ½-inch additional height and 4.55 cubic feet oven capacity.

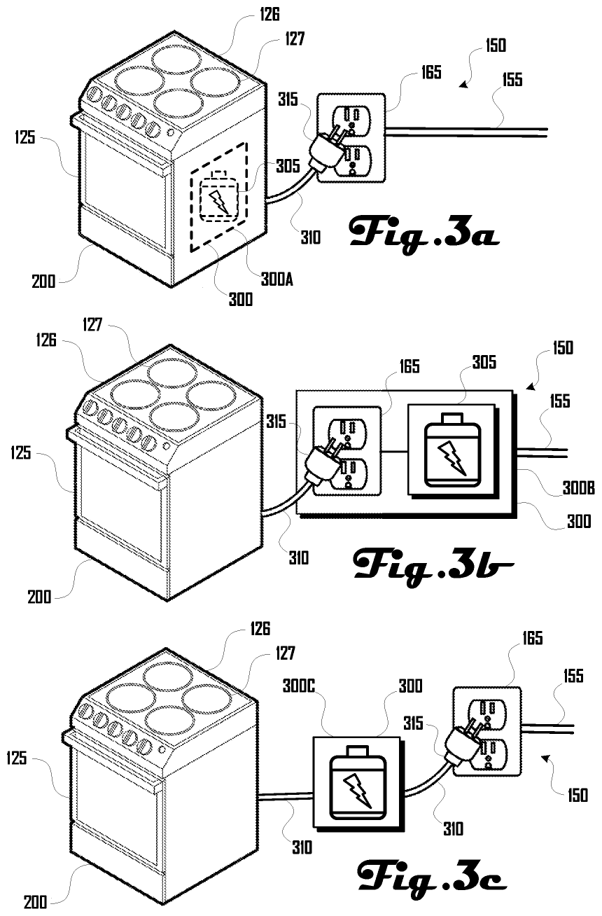

As discussed in more detail herein, in various embodiments load sources 200 can be respectively associated with a battery 305 and/or battery system 300 (See e.g., FIGS. 3a, 3b and 3c); however, in some embodiments, the powered building system 100 can comprise one or more building system batteries 170 that is not directly associated with a specific load sources 200, and can be configured to store energy for the powered building system 100 generally for distribution to the electrical power grid 110, to the load sources 200 associated with the powered building system 100, or the like. In some embodiments a building system battery 170 can be absent.

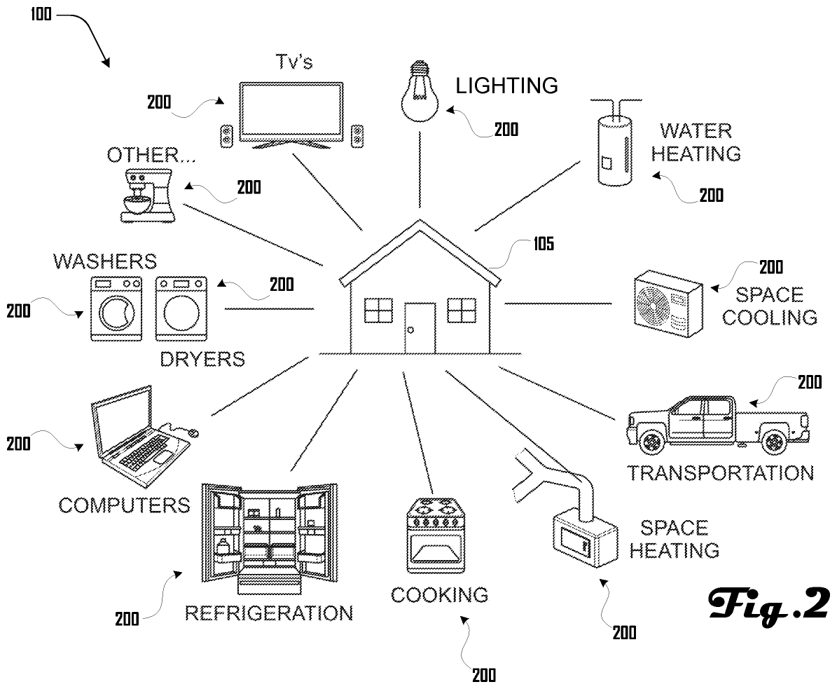

While FIG. 1 illustrates one example embodiment of a powered building system 100, such an embodiment should not be construed to be limiting on the wide variety of load sources 200 that can be powered, associated with a battery and/or battery system, or the like. For example, FIG. 2 illustrates further examples of load sources 200 that can be associated with the powered building system 100 in further embodiments. Additionally, while various embodiments of a powered building system 100 can relate to a single-family residential home, it should be clear that further embodiments can relate to multi-family residences, mixed-use buildings, commercial buildings, laboratories, factories, airports, farms, or other suitable building, structure, or land. Additionally, some embodiments can be applicable to vehicles or structures such as a cruise ship, offshore platform, airplane, bus, or the like.

Also, while the example of FIG. 1 illustrates a powered building system 100 associated with an electrical power grid 110, such as regional electrical power provider that provides power to a plurality of buildings 105 and/or powered building systems 100, in further embodiments a powered building system 100 may not be associated with or connected to an electrical power grid 110. Additionally, while the example of FIG. 1 illustrates a powered building system 100 that obtains electrical power from one or more solar panels, in further embodiments any suitable additional or alternative electrical power generation systems and methods can be part of a powered building system 100, such as a wind turbine, water turbine, geothermal power generator, nuclear power system, chemical or combustion power generator, or the like.

First, such an approach can place energy storage into homes more cost effectively than the status quo. As the order-of-magnitude discrepancy between EV and home battery prices demonstrates, factory installation of batteries in appliances rather than homes can be significantly less expensive, as no inspections or custom electrical work may be required. As a homeowner replaces appliances at end-of-life, additional storage capacity enters the home by default along with the new appliance, which may require no customizations or electrical work in various embodiments. In this way, in various examples, homes can naturally gain the ability to shift demand and meet a greater portion of their energy needs using renewables via a standard technological upgrade cycle—for example, at no point does the homeowner need to opt to buy a $10,000 home battery, nor do they need to hire an electrician to come install it.

Further, various embodiments of such an approach can eliminate significant upgrade costs required to replace fossil fuel appliances. Many electric appliances (e.g., induction ranges and electric dryers) require dedicated high-capacity circuits to be installed, but only draw their full capacity for short periods of time. This electrical work can significantly increase the cost of such an upgrade, providing a large barrier to entry, and can negate any value proposition the increased efficiency of these more advanced appliances may provide. As an example, a four-burner induction cooktop with oven on its own runs from $1,000-$2,000, and (in the case where an appropriate 240V circuit is already available) can be installed by the homeowner or a general contractor for $150-$200. If this range is replacing a natural gas stove, however, the likelihood that an appropriate, unused circuit is available at the correct location is very low, and the cost to install the required 30-40-amp appliance circuit is roughly $800-1,000, with an additional $380-$460 required if the routing from the circuit breaker to the stove is long or inconvenient. Further, in most cases the available electrical service was designed assuming fossil fuel use and is insufficient for this large additional circuit. Upgrading the service panel in this situation can add an additional $1,500-$4,000 on top of the project cost, making the total cost of replacing the natural gas stove a factor of 2-6 higher than the underlying new appliance cost.

In various embodiments, appliances with integrated or associated batteries as discussed herein can eliminate the need to upgrade electrical service, as they can supply the required high current during use, while only drawing meager average power from an existing 110 v electrical outlet to recharge. In the case of the induction stove, the overwhelming majority of dinnertime cooking needs can be met by a 0.75-1.5 kWh integrated battery, where the modeled dinnertime cooking demands of 3000 homes over the 365 days of the year have been aggregated into a histogram. This battery adds a mere $100-$200 to the appliance cost if installed in the factory at current EV prices, and less as the scale of this industry continues to bring costs down. As a result, the total project cost to the homeowner to eliminate this source of residential emissions remains predictable and low, and the dinnertime cooking loads, which occur largely outside the productive window for solar, can be cost-effectively shifted to be powered by renewables.

Additionally, centralized main home batteries can require large, dedicated inverters to supply AC power, even when many appliances (like induction stoves) use internal rectification to convert the power back to DC. Placing batteries at these points of load can allow direct DC powering of the appliance, with only modest AC draw from the electrical outlet in various embodiments. On a systemic level, in various embodiments this can eliminate the inversion-rectification cycle on power drawn and deferred from the grid, and significantly reduce the power requirements on an inverter supplying power from a rooftop solar array. The result can be a reduction in system cost, and an efficiency increase due to eliminated power conversions.

Also, large battery packs that may be required for main home batteries are often spoiled by a single bad cell. In contrast, a ˜1 kWh commoditized pack that can be used to power a home appliance can be easier to manage than centralized batteries, and in various embodiments can be made easier to replace in the event of failure. Having fewer cells under a battery management system (BMS) can allow, in some embodiments, better control over charge cycle, mechanical, and thermal stress and more robust health diagnostics, leading to longer battery life. Battery management systems and supporting power electronics can be at a price point such that an increased number of them does not present a cost barrier. As an additional benefit to this approach, in some embodiments smaller battery packs used for point of load storage can be more appropriate for second-life applications of plug-in EV batteries—supply of which is expected to grow rapidly in the next ten years. Even after use in an EV, such cells are expected to have 70% of their initial capacity and be viable for another ten years in their second-life application.

Turning to FIGS. 3a, 3b and 3c, various example embodiments of battery systems 300 comprising one or more batteries 305 are illustrated. In the example embodiments of FIGS. 3a, 3b and 3c a stove 125 load source (e.g., an induction stove) is shown being associated with a battery system 300 or having an internal a battery system 300, but it should be clear that various other suitable load sources 200 can be applicable in various embodiments. In various embodiments, a stove 125 load source 200 can comprise a stove top 126 with a plurality of burner areas 127 (e.g., four). As discussed in more detail herein, in various embodiments the burner areas 127 can be associated with a respective inductive coil, heating element, or the like, that generates heat for cooking.

FIG. 3a illustrates an example of a stove 125 load source 200 that comprises an embodiment 300A of a battery system 300 having a battery 305. For example, the battery system 300A can be an internal component of the stove 125, an integral component of the stove 125, disposed within a housing of the stove 125, or the like. For example, in some embodiments, a portion of the battery system 300A and/or battery 305 can be an integral part of the stove 125 such that such portions cannot be removed or easily removed from the stove 125, which can include, in some examples, such portions being enclosed within a housing of the stove 125 so that such portions are not accessible externally to users. However, in some examples, the battery 305 can be removable, replaceable, and/or modular as discussed herein.

As shown in FIG. 3a, the stove 125 can comprise a power cord 310 with a plug 315 configured to couple with an electrical power receptacle 165 of a power distribution system 150. For example, the power distribution system 150 can provide power to the receptacle 165 via power lines 155, where the receptacle 165 is disposed on a wall of a building 105 (FIG. 1) with power lines 155 running though the wall, or the like. The stove 125 can plug into the receptacle 165 which can provide electrical power to the stove 125 and the battery 305 of the battery system 300, which can be configured to store electrical power and/or provide electrical power to the stove 125 as discussed herein.

In some embodiments, one or more batteries 305 and/or battery systems 300 can be integrated into a load source 200 (e.g., into an appliance housing) at the factory where the load source is manufactured or can be integrated into load source aftermarket. For example, load sources 200 (e.g., appliances) can be specifically designed to allow integration of the appropriate quantity of batteries 305 and/or other elements of a battery system 300 within their normal housing. This can allow for such load sources 200 or appliances to be placed within a residence without any change to how they are integrated into standardized fixturing, such as counters. In various embodiments, electrical connections to batteries 305 and/or other elements of a battery system 300 are made in the factory and fully integrated into the appliance circuit. This can allow for load sources 200 such as appliances that utilize DC current (e.g., induction stove) to pull power directly from the one or more batteries 305 without the added cost of a high-power inverter.

In some embodiments, batteries can be designed to be integrated into load sources (e.g., appliances) in an aftermarket factory setting. For example, a company that is not the original equipment manufacturer of an appliance buys new appliances, installs the battery system 300 in their own facility, and re-sells the appliance as new. The retrofitter in some examples installs the one or more batteries 305 and/or elements of the battery system 300 within the housing of the appliance, wiring them directly into the integral electrical system of the appliance. This can be desirable in some embodiments if high-voltage connections are required given the danger of such high-voltage connection if not being handled by a professional. Also, in some embodiments where a load source 200 (e.g., an appliance) has an internal rectification circuit, such as an induction stove or the like, that is converting 60 Hz AC current to DC, it can be desirable in some examples to connect the battery system 300 directly into the internal circuitry of the load source (e.g., to avoid costly addition of high-power inversion).

FIG. 3b illustrates another example embodiment 300B of a battery system 300 having a battery 305 and a receptacle 165. For example, the battery system 300B can be part of a power distribution system 150 and can be disposed on and/or in a wall of a building 105 and can comprise the receptacle 165 and the battery 305 that are configured to receive electrical power from a power line 155. In various embodiments, the receptacle 165 and/or battery 305 can be an internal component of the battery system 300B, an integral component of the battery system 300B, disposed within a housing of the battery system 300B, or the like. For example, in some embodiments, a portion of the receptacle 165 and/or battery 305 can be an integral part of the battery system 300B such that such portions cannot be removed or easily removed from battery system 300B, which can include, in some examples, such portions being enclosed within a housing of the battery system 300B so that such portions are not accessible externally to users aside from interface plugs of the receptacle. However, in some examples, the battery 305 can be removable, replaceable, and/or modular as discussed herein.

As shown in FIG. 3b, the stove 125 can comprise a power cord 310 with a plug 315 configured to couple with the electrical power receptacle 165 of the battery system 300B. For example, the battery 305 of battery system 300B and/or the power distribution system 150 (via power lines 155) can provide power to the receptacle 165, where the receptacle 165 is disposed on a wall of a building 105 (FIG. 1) with the power lines 155 running though the wall, between the outlet and the appliance, or the like. The power lines 115 can be configured to provide electrical power to the battery 305, which can be stored by the battery 305 as discussed herein.

In some embodiments, batteries 305 and elements of a battery system 300 are designed to nest with load sources (e.g., appliances), either as a footing, or a backing, etc. Such nesting can be done by the customer in various examples. Batteries 305 and/or elements of a battery system 300 can be designed to nest directly external to the appliance, such as by taking into consideration the shape and intended location of the appliance within a house 105. One or more batteries 305 and elements of a battery system 300 (e.g., power control stage) are packaged in such a way in various examples such that they can be placed directly alongside the appliance. The appliance can be plugged into the battery system 300 and the battery system 300 is then plugged into the wall.

For example, batteries 305 and/or elements of a battery system 300 can be packaged in some embodiments as a flat plate that is sized the same as, similar to, not exceeding, or slightly less than the footprint of a conventional refrigerator, whose widths and depths are often standardized to match counter depths. Such a refrigerator in some examples would be placed on top of the low-profile battery pack, effectively joining the appliance and added storage without any great disturbance to the use, appearance, or placement of the appliance.

Batteries 305 and/or battery systems 300 can be designed to be placed at outlet faceplates in various embodiments. For example, batteries 305 and/or battery systems 300 can be packaged in flat plates that plug directly into standard wall outlets. These plates can be designed to be low profile and can allow an appliance to be pushed up against the wall as it is normally intended to do. The batteries 305 and/or battery systems 300 can be affixed to the wall directly behind an appliance, in some embodiments, such as a dryer, refrigerator or hot water heater, in a way that there is very little change in the placement of the machine.

FIG. 3c illustrates another example embodiment 300C of a battery system 300 having a battery 305 and a power cord 310 with a plug 315. For example, the battery system 300C can be a unit disposed between the stove 125 load source 200 and a receptacle 165 that is part of a power distribution system 150. The receptacle 165 can be disposed on and/or in a wall of a building 105 and can be configured to receive electrical power from a power line 155.

In various embodiments, the battery 305 can be an internal component of the battery system 300C, an integral component of the battery system 300C, disposed within a housing of the battery system 300C, or the like. For example, in some embodiments, the battery 305 can be an integral part of the battery system 300C such that such portions cannot be removed or easily removed from battery system 300C, which can include, in some examples, such portions being enclosed within a housing of the battery system 300C. However, in some examples, the battery 305 can be removable, replaceable, and/or modular as discussed herein.

As shown in FIG. 3c, the battery system 300C can comprise a power cord 310 with a plug 315 configured to couple with the electrical power receptacle 165 of the power distribution system 150. For example, the power distribution system 150 (via power lines 155) can provide power to the receptacle 165, where the receptacle 165 is disposed on a wall of a building 105 (FIG. 1) with the power lines 155 running though the wall, or the like. The receptacle 165 can be configured to provide electrical power to the battery 305, which can be stored by the battery 305 as discussed herein and can power the stove 125 load source 200. Additionally, in various embodiments, the receptacle 165 can be configured to provide electrical power to the stove 125 load source 200 via the battery system 300C. The stove 125 can be electrically coupled to the battery system 300C in various suitable ways, including directly via a power cord 310 or via a power cord 310 that removably plugs into the battery system 300C via a plug 315 or other suitable elements.

Additionally, it should be clear that a powered building system 100 can include any suitable number and type of battery systems 300 including one or more of the battery systems 300 shown in FIGS. 3a, 3b and 3c. However, in some examples one or more of the one or more of the battery systems 300 shown in FIGS. 3a, 3b and 3c can be specifically absent.

One example embodiment includes a first battery system that is an integral component of and disposed within a housing of a first load source of the plurality of load sources, the first load source comprising a first power cord plugged into a first receptacle of the plurality of receptacles, the first battery system comprising a first battery configured to obtain and store power from the first receptacle, the first load source being configured to be fully powered by power stored by the first battery and configured to be fully powered by power obtained from the first receptacle and configured to be partially powered by both the first battery and power obtained from the first receptacle; a second battery system that includes a second battery and a second receptacle of the plurality of receptacles, the second battery system disposed within a wall of the building, with a second load source comprising a second power cord plugged into the second receptacle of the plurality of receptacles, with the second battery configured to obtain and store power from the electrical power distribution system, the second load source being configured to be fully powered by power stored by the second battery and configured to be fully powered by power obtained from the electrical power distribution system and configured to be partially powered by both the second battery and power obtained from the electrical power distribution system; and a third battery system electrically disposed between a third load source and a third receptacle of the plurality of receptacles, the third battery system comprising a third electrical power cord plugged into the third receptacle, with the third load source comprising a fourth power cord plugged into a fourth receptacle of the third load source, the third battery system comprising a third battery configured to obtain and store power from the third receptacle, the third load source being configured to be fully powered by power stored by the third battery and configured to be fully powered by power obtained from the third receptacle via the third battery system and configured to be partially powered by both the third battery and power obtained from the third receptacle via the third battery system.

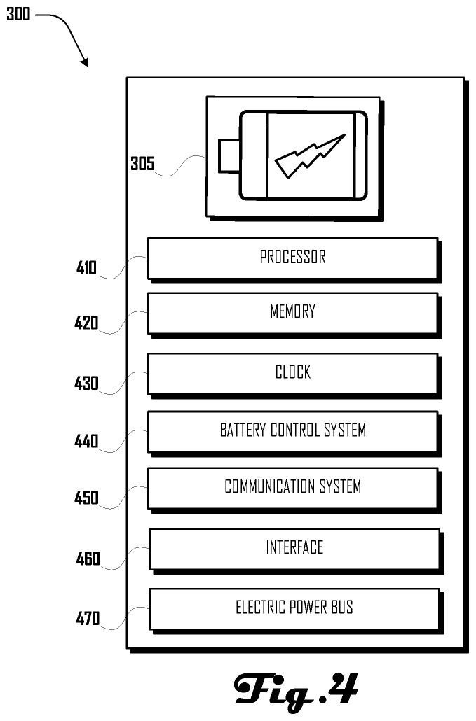

A battery system 300 can comprise various suitable elements. For example, FIG. 4 illustrates one example embodiment of a battery system 300, which can comprise one or more batteries 305, a processor 410, a memory 420, a clock 430, a battery control system 440, a communication system 450, an interface 460 and an electrical power bus 470.

For example, in some embodiments, a battery system 300 can comprise a computing device which can be configured to perform methods or portions thereof discussed herein. The memory 420 can comprise a computer-readable medium that stores instructions, that when executed by the processor 410, causes the battery system 300 to perform methods or portions thereof discussed herein, or other suitable functions. The clock 430 can be configured to determine date and/or time (e.g., year, month, day of the week, day of the year, time, and the like) which as discussed in more detail herein, can in some examples be used to configure the power storage and/or power discharge of the battery 305 based on time.

The battery control system 440 in various embodiments can be configured to control power storage and/or power discharge of the battery 305 based on instructions from the processor, or the like. Additionally, in some embodiments, the battery control system 440 can determine various aspects, characteristics or states of the battery 305 such as a charge state (e.g., percent charged or discharged), battery charge capacity, battery health, battery temperature, or the like. For example, in various embodiments, a battery system 300 can comprise various suitable sensors to determine such aspects, characteristics or states of the battery 305 or aspects, characteristics or states of other elements of a building system 100 which can include environmental conditions such as temperature, humidity, or the like internal to or external to a building 105.

In various embodiments, the communication system 450 can be configured to allow the battery system 300 to communicate via one or more communication networks as discussed in more detail herein, which in some embodiments can include wireless and/or wired networks and can include communication with devices such as one or more other battery systems 300, user device, server, or the like.

The interface 460 can include various elements configured to receive input and/or present information (e.g., to a user). For example, in some embodiments, the interface can comprise a touch screen, a keyboard, one or more buttons, one or more lights, a speaker, a microphone, a haptic interface, and the like. In various embodiments, the interface 460 can be used by a user for various suitable purposes, such as to configure the battery system 300, view an aspect, characteristic or state of the battery system 300, configure network connections of the battery system 300, or the like.

The electrical power bus 470 can be configured to obtain electrical power from one or more sources and/or provide electrical power to one or more load sources 200. For example, in various embodiments, the electrical power bus 470 can obtain power from one or more power receptacles 165 (see e.g., FIGS. 3a and 3c) or other suitable interface with a power distribution system 150, or directly from a power source such as an electrical power grid 110, solar panel 115, or the like. Such obtained electrical power can be stored via one or more batteries 305 or can be directed to one or more load sources 200 connected to the battery system 300. Such obtained electrical power can be directed to such one or more load sources 200 via the one or more batteries 305 or bypassing the one or more batteries 305.

The one or more batteries 305 can be any suitable system configured to store and discharge energy. For example, in some embodiments, the one or more batteries 305 can comprise Lithium Iron Phosphate (LiFePO4), rechargeable lead-acid, nickel-cadmium (NiCd), nickel-metal hydride (NiMH), lithium-ion (Li-ion), lithium-ion polymer (LiPo), rechargeable alkaline batteries, or the like. As discussed herein, rechargeable in various embodiments can be defined as having the ability to store and discharge energy multiple times without substantial degradation of the ability store and discharge energy for at least a plurality of cycles (e.g., 5, 10, 50, 100, 500, 1000, 10 k, 100 k, 1 M, 10 M, 100 M, or the like). While various preferred embodiments can include chemical storage of electrical energy, in further embodiments one or more batteries 305 can be configured to store energy in various suitable ways, such as mechanical energy, compressed fluid, thermal energy, and the like.

In some embodiments, the one or more batteries 305 can contain or be defined by removable cartridges that allow the one or more batteries 305 to scale or be replaced. Battery packs in some examples can be composed of small sub-packs that can be easily removed. This can allow for old or faulty cells to be replaced in some examples. Additionally, in some examples such a configuration allows for the fine tuning of pack size within a network of battery systems 300 as discussed herein. For example, one or more batteries 305 can be initially sized and colocated with an expected load source 200.

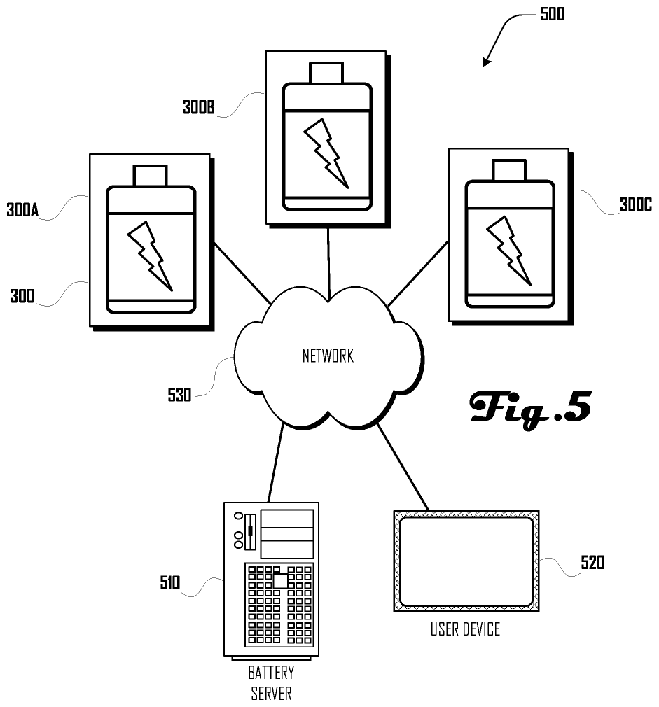

As the battery system 300 (or a powered building system 100 or battery network 500) monitors and learns the particular behavior of the load source 200, user behavior related to the load source 200, and the like, a determination may be made that the size of one or more batteries 305 of the battery system 300 is too large or too small. Likewise, a different battery system 300 on the network of battery systems 300 may determine that its pack is too large or too small or another device may make such a determination as discussed herein. In some embodiments, a battery system 300 can indicate via an interface 460 that the battery system 300 would be better utilized if a sub-pack (e.g., one or more batteries 305 of a plurality of batteries) were moved from one load source 200 to the other (e.g., by moving one or more batteries 305 from a first battery system 300 to a second battery system 300 within a powered building system 100). Methods of determining a configuration of one or more batteries 305 of a powered building system 100 or battery network 500 (see FIG. 5) are discussed in more detail herein.

It should be clear that the example of FIG. 4 is only one example embodiment of a battery system 300 and that battery systems 300 having fewer or more elements or having more or less complexity are within the scope and spirit of the present disclosure. For example, one or more of the elements of FIG. 4 can be specifically absent in some embodiments, can be present in any suitable plurality, or the like. In some embodiments, a communication system 450 can be absent and the battery system 300 can be inoperable for wired and/or wireless communication with other devices. In some embodiments, elements such as processor 410 and clock 430 can be absent. The interface 460 can comprise a plurality of interface elements or a complex interface in some examples or can be a simple interface 460 in some embodiments, or can be absent. In some embodiments, an interface for the battery system 300 can be embodied on a separate device such as a user device (e.g., a smart phone, laptop, home automation system, or other suitable device). Additionally, battery systems 300 can be various suitable sizes, including systems that weigh 1-5 pounds, 10-30 pounds, 50-100 pounds, 150-500 pounds, 500-1,500 pounds, or the like.

Turning to FIG. 5, an example embodiment of a battery network 500 is illustrated that comprises three battery systems 300A, 300B, 300C, a battery server 510 and a user device 520, which are operably connected via a network 530. In various embodiments, the network can comprise various suitable wired and/or wireless networks, including Wi-Fi, Bluetooth, a wired connection, a cellular network, the Internet, a local area network (LAN), wide area network (WAN), a wired connection, or the like. In various embodiments, the battery systems 300A, 300B, 300C can communicate with each other and/or the battery server 510 and user device 520 via a communication system 450 (see FIG. 4).

In some embodiments, the battery systems 300 can obtain data from, send data to, or be controlled by one or both of the battery server 510 and user device 520 as discussed in more detail herein. In some embodiments, the battery server 510 and/or user device 520 can be remote from or proximate to the battery systems 300 of the battery network 500. For example, in some embodiments, the battery systems 300 can be disposed within or associated with load sources 200 of a house and the user device 520 can be used to configure the battery systems 300 individually or collectively. The user device 520 can be a smart phone in some examples, and may be used by a user while in or around the house or used while the user is remote from the house. In some examples, the battery server 510 can be a remote physical or cloud-based server or server system that can be configured to store data related to the battery systems 300, store data provided by the battery systems 300 and/or user device 520, or configure the battery systems 300 and/or user device 520 as discussed in more detail herein.

While the embodiment of a battery network 500 of FIG. 5 shows one example, it should be clear that numerous suitable additional configurations of a battery network 500 are within the scope and spirit of the present disclosure. For example, in further embodiments, any suitable plurality of battery systems 300 can be part of a battery network 500 including 1, 2, 3, 4, 5, 6, 7, 8, 9, 10, 20, 50, 100, 1 k, 10 k, 100 k, 1 M, 5 M, 10 M, 50 M, or the like. Similarly, there can be any suitable number of battery servers 510 and user devices 520 or one or both of a battery server 510 and user device 520 can be absent. Additionally, in some examples, a battery server 510 and/or user device can be part of one or more battery systems 300 and need not be a separate element as shown in the example of FIG. 5. For example, in some embodiments, there can be a network of a plurality of battery systems 300 with one or more of such battery systems having the capabilities, functionalities, elements or the like of one or both of a battery server 510 and user device 520. For example, a mesh network of a plurality of battery systems 300 can have a central hub battery system 300 that controls, stores data for, or provides data to the entire network.

In various embodiments, there may be different sets of batteries that are associated with a given user or administrator in a battery network 500. For example, in some embodiments there can be a plurality of separate powered building systems 100 (see e.g., FIG. 1) that each comprise a plurality of battery systems 300 and each of these separate powered building systems 100 can be associated with a different user or administrator and respectively controlled by a different user device 520 associated with the different user or administrator. However, in some embodiments, all of such separate powered building systems 100 can communicate with the same battery server 510, which can be configured to store data associated with different user or administrator accounts associated with the different powered building systems 100. Such pooled data can be used to configure, or provide information to the plurality of different powered building systems 100 as discussed in more detail herein, including network-wide, worldwide, country-wide, statewide, county-wide, town-wide, block-wide, or the like.

Despite the listed advantages of appliance-integrated batteries and batteries associated with appliances discussed herein (e.g., battery systems 300), the described approach of various embodiments can be a significant perturbation to the status quo in some examples and can come with a number of risks. For example, a naive implementation of point-of-use batteries may result in an increase in the total capacity of storage required for a home. If the size of an appliance battery 305 or appliance-associated battery 305 is poorly matched to the patterns of energy demand, some of the capacity may remain unused, resulting in wasted reserves. The mitigation strategies for this risk can include one or more of the following.

For example, the sizing of batteries 305 in some embodiments can be based on data analytics and predictive models of use, to enable the best correlation between estimates of load shift and performance in the field. In some examples, such sizing can include determining a size of one or more batteries 305 that is to be installed integrally within a given load source 200 based on anticipated use within a given powered building system 100, location within a powered building system, regional location, or the like. Similarly, in some embodiments, a user can be provided with a suggestion for a size of battery 305 to associate with a given load source 200, which may include suggestions on a size of a modular battery 305 to associate with a load source 200 (e.g., internally, externally, within a wall receptacle, or the like).

Additionally, as discussed herein, a powered building system 100 or battery network 500 can comprise a plurality of battery systems 300 associated with respective load sources 200 with each of the battery systems 300 comprising one or more modular batteries 305. In various embodiments, the powered building system 100 or battery network 500 can monitor the plurality of battery systems 300 and determine whether modular batteries 305 should be removed from the battery systems 300; should be added to the battery systems 300; should be moved from one battery system 300 to another battery system 300; should be removed and replaced with a larger or smaller modular battery 305; should be removed and replaced with a healthier battery 305; or the like. In some embodiments, such monitoring can be done by one battery system 300 of a plurality of battery systems 300, by a battery server 510, by a user device 520, or the like.

For example, a method of determining a configuration of a plurality of batteries 305 of a plurality of battery systems 300 within a powered building system 100 or battery network 500 can comprise obtaining data regarding a current configuration of the plurality of batteries 305. For example, in some embodiments, batteries 305 plugged into battery systems 300 can have an identifier that indicates characteristics of the battery 305 (e.g., a unique battery identifier, a battery model identifier, or the like) or information regarding battery configuration can be input by a user. In some embodiments, such battery configuration data can be obtained directly from interrogation of the plurality of battery systems 300, can be stored in a user power profile, indicated by a user, or the like.

The method can further include monitoring use and/or performance of the plurality of batteries 305 and/or battery systems 300. For example, such use and/or performance data can be stored in a user power profile. A determination can be made whether a change should be made to the current battery configuration based on the use and/or performance data, the current battery configuration, characteristic of desirable and/or undesirable performance of the batteries 305, battery systems 300, powered building system 100, battery network 500, or the like. If a determination is made that a change to the current battery configuration should be made (e.g., it would be desirable to make a change), then one or more suggested changes can be indicated to a user (e.g., via an interface 460, user device 520, or the like). Such a determination can be made based on available additional capacity (e.g., open battery slots where additional batteries can be coupled to one or more battery systems 300), ability to swap different sizes of batteries (e.g., battery slots that allow for larger and/or smaller batteries being swapped), or the like.

For example, a determination can be made that a powered building system 100 or battery network 500 would be able to store and/or use more renewable energy (e.g., from solar panels 115), instead of using power from the grid 110 by increasing the size of one or more batteries 305. In some examples, increasing total battery storage capacity of the powered building system 100 or battery network 500 regardless of location of battery systems 300 (e.g., regardless of load source 200 associated with the battery system) may be suitable.

However, in some examples, increasing the capacity of a battery system 300 associated with a specific load source 200 that frequently consumes an amount of energy that is more than the capacity of the one or more batteries 305 of the battery system 300 can be desirable. In other words, it can be determined that increasing the storage capacity at a given battery system 300 can allow sufficient renewable power to be stored such that typical use of a load source 200 associated with that given battery system 300, when renewable power is not directly available, does not require (or requires less) grid power to be used to power that load source 200, which can be desirable from a cost and/or environmental perspective.

In some examples, a determination can be made to decrease the capacity of a battery system 300 associated with a specific load source 200, such as when energy storage capacity of one or more batteries 305 of the battery system 300 is only minimally or rarely used (e.g., a maximum of 5%-10% of the battery storage capacity is ever used). In such an example, it may be desirable to re-deploy one or more batteries 305 to another battery system 300 where storage capacity can be better utilized or to decrease the physical size of the battery system 300, which may be desirable to reduce visibility of the battery system 300 or to allow for more desirable placement of a load source 200 (e.g., appliance) about the battery system 300.

In another example, a determination can be made that one or more batteries 305 of a battery system have decreasing performance over time, which may be indicative of the one or more batteries failing and may make it desirable for such one or more batteries 305 to be indicated for replacement or removal (e.g., due to poor performance, fire danger, or the like).

In a further example, a determination can be made that a different type of battery 305 may be desirable for coupling with a battery system 300 associated with a given load source 200 given how such a load source 200 is used or operates. For example, where a given load source 200 is typically used for a short period of time at high power, then a determination can be made to replace a first battery 305 with a second battery that has better performance for such power use. Similarly, where a load source 200 is constantly on at low power, a determination can be made to replace a first battery 305 with a second battery that has better performance for such power use.

While some examples of determining battery configuration can relate to a powered building system 100 or battery network 500 having a plurality of battery systems 300, in some embodiments such battery configuration determination can relate to a powered building system 100 or battery network 500 having only a single battery system 300 or can be applied at the level of a single battery system 300 (e.g., regardless of and unaware of whether there are other battery systems 300 present in the powered building system 100 or battery network 500).

Also, while various embodiments relate to determining battery configurations for long-term use to support typical use of load sources 200, in some embodiments atypical or acute power needs can be identified and a temporary battery configuration can be suggested. For example, in exceptional circumstances, when usage patterns deviate from the norm, one or more batteries 305 can be moved between end uses (e.g., between different battery systems 300). In some examples, sub-packs can be brought from one load source 200 to the other to facilitate this need. In another example, a suggestion can be made to add a battery 305 to a battery system 300 or to swap-in a changed battery 305 to accommodate a temporary or atypical power need (e.g., during a power grid outage, during holidays when more cooking may be done, during a heat wave, or the like).

In various embodiments, removal, insertion or swapping of batteries 305 can be performed manually by a user. However, some embodiments can comprise a mobile autonomous device that carries power between appliances via portable battery or battery swapping.

Additionally, in some embodiments, on-board or network control laws can be adaptive to patterns of use, which can allow a given battery capacity to adapt to expected demands. Further, these laws in various embodiments can be configured to adapt to local time-of-use rates, allowing behind-the-scenes energy arbitrage. Implementation of these control laws can be based on reinforcement learning and controls techniques, accompanied by best practice user interfaces allowing homeowner monitoring and tuning.

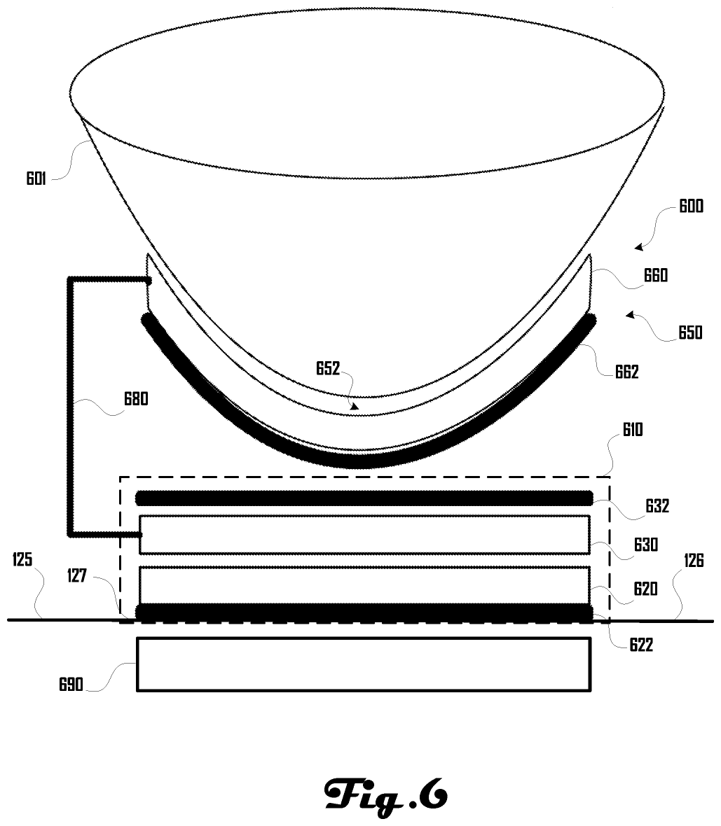

Turning to FIG. 6, an example embodiment of an inductive heating adapter 600 is illustrated which comprises a base portion 610 and an adapter portion 650 that are electrically coupled via a connection 680 (e.g., a wire). The base portion 610 comprises a first coil 620 and a second coil 630, which are disposed between a first ferrite 622 and a second ferrite 632. The adapter portion 650 defines a cavity 652 and comprises a third coil 660 and a third ferrite 662.

As shown in this example, the inductive heating adapter 600 can be disposed on a burner area 127 of a stove top 126 of a stove 125 with a cooking vessel 601 disposed within the cavity 652 defined by the adapter portion 650. The burner area 127 of the stove 125 can comprise a stove coil 690 disposed below or within the stove top 126. In various embodiments, the first coil 112 and the second coil 114 of the base portion 610 can serve as intermediary wireless transformers to convey electrical power up to the adapter portion 650 via the connection 680, which in turn inductively heats the cooking vessel 601.

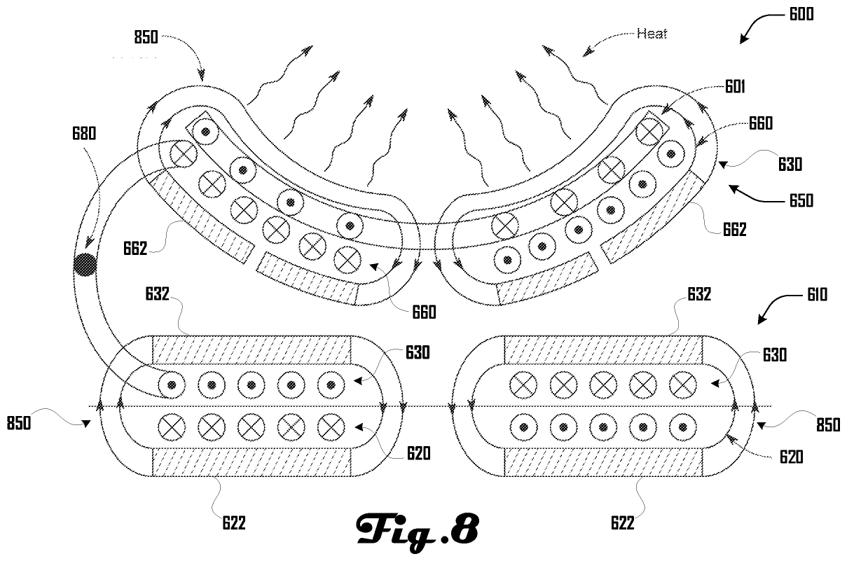

For example, in various embodiments the first coil 620 can be planar and positioned in proximity to a stove coil 690 of an inductive stove 125 (e.g., on a stove top 126 at a burner area 127). In various embodiments, the second coil 630 may be flat and positioned in proximity to the first coil 112 such that the first coil 620 induces a counteracting current 850 in the second coil 620 (see e.g., FIG. 8). The third coil 660 can be electrically connected to the second coil 630 (e.g., via the connection 680) which can drive the current in the third coil 660. The third coil 660 may be curved or have another specialized or desirable form factor geometry such that a curved cooking vessel 610 (e.g., pot or pan) may be set in sufficient proximity of the third coil 660 (e.g., in the cavity 652) to cause a counteracting current 850 to be induced in the cooking vessel 610 to cause inductive heating of the cooking vessel 601 and thereby allow for inductive cooking in the cooking vessel 601.

In some embodiments, the base portion 610 can be a unitary body comprising the first and second coils 620, 630 and the first and second ferrites 622, 632. For example, the first and second coils 620, 630 and the first and second ferrites 622, 632 can be disposed together within a housing. However, in some embodiments, the base portion can comprise any plurality of separate bodies, units, pieces, or the like (e.g., 2, 3, 4 or the like). For example, in one embodiment, the first coil 620 and first ferrite 622 be disposed together (e.g., within a first housing) and the second coil 630 and second ferrite 632 be disposed together (e.g., within a second housing that is separate from the first housing).

Such an embodiment where the base portion 610 comprises two separate pieces can be desirable in some examples to allow for different versions of such elements to be used such as use of different sizes of a first coil 620, different types of a first coil 620, different configurations of a first coil 620, or the like, which may be desirable based on different stoves 125, stove tops 126, burner areas 127, and the like. In some examples, such a modular configuration can be desirable to allow for use of different adapter portions 650. Additionally, as discussed one or both of the first and second ferrites 622, 632 can be absent from the base portion 610 or pieces thereof.

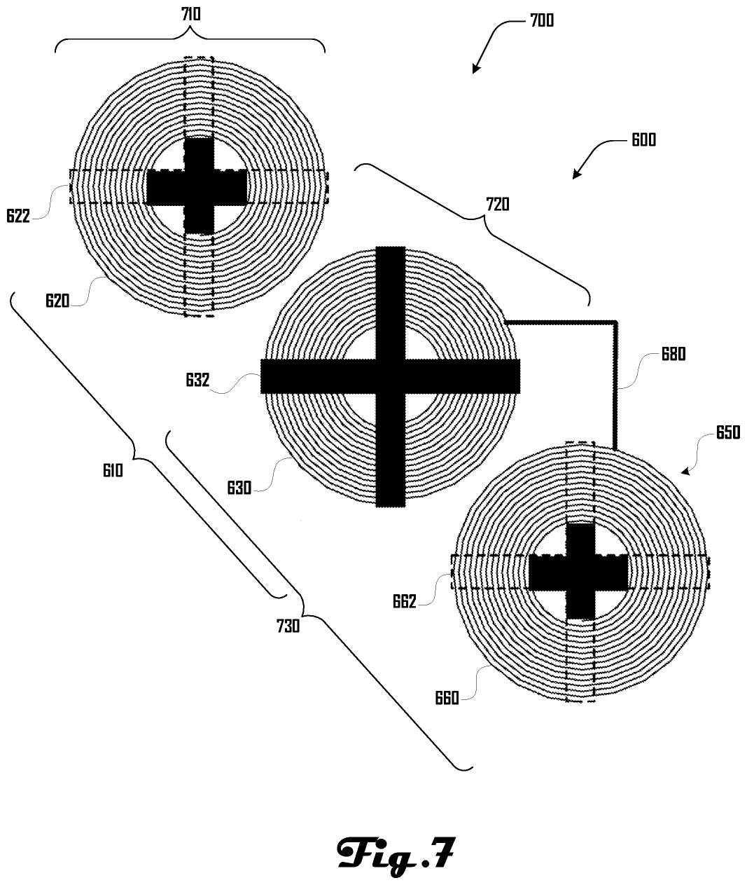

In some embodiments, the adapter portion 650 can be separate from base portion 610 or a portion of the base portion 610 aside from a connection 680 or the adapter portion 650 can be coupled to the base portion 610 or a portion of the base portion 610. For example, FIG. 7 illustrates an embodiment 700 of an inductive heating adapter 600 and where a base portion 610 comprises a first unit 710 and a separate second unit 720 where the first unit 710 comprises a first coil 620 and first ferrite 622 and the second unit 720 comprises a second coil 630 and second ferrite 632. The second unit 720 and the adapter portion 650 can be at least coupled via a connection 680 and can define a top unit 730.

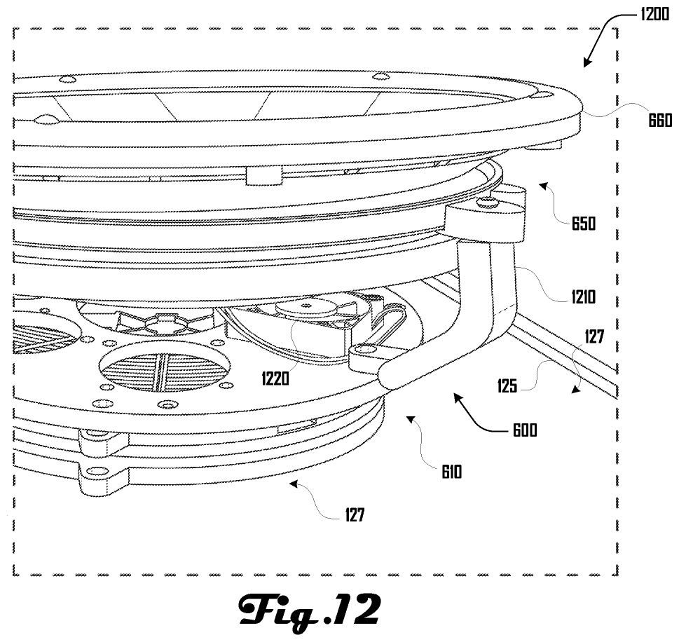

FIG. 12 illustrates an embodiment 1200 of an inductive heating adapter 600 where a base portion 610 is coupled with an adapter portion 650 via a plurality of adapter arms 1210 (only one adapter arm 1210 of the plurality visible in FIG. 12), which fixes the adapter portion 650 over the base portion 610 or a portion thereof. For example, such a base portion can be a single unitary unit or can comprise a separate first and second unit. In some embodiments, one or more connections 680 can run about or in one of the adapter arms 1210. In various embodiments, the adapter portion 650 can be coupled above the base portion 610 via the plurality of adapter arms 1210 such that respective centers of the first coil 620, second coil 630, third coil 660 and center of the concave curved cavity 652 are disposed along a common axis. In further embodiments, the adapter portion 650 can coupled above the base portion 610 in various suitable ways.

In some modular embodiments, use of an inductive heating adapter 600 can comprise placing a first body (e.g., comprising a first coil 620) on a burner area 127 of a stove top 126 of a stove 125 over a stove coil 690 and placing a second body (e.g., comprising a second coil 630) on the first body. Some embodiments can include complementary grooves, notches, pins, slots, or the like (e.g., defined by one or both of the first body and/or the second body), which in some examples can be configured for proper alignment or coupling of the second body on the first body. In some embodiments, the adapter portion 650 can be coupled to the second unit or the adapter portion 650 can then be placed on the second unit. A cooking vessel 601 can be disposed in the cavity 652 of the adapter portion 650. The stove coil 690 of the burner area 127 can be turned on, which can generate electrical current in the connection 680 via the base portion 610 and cause inductive heating of the cooking vessel 601 via the adapter portion 650.

While various embodiments discussed herein related to an adapter portion 650 and separate cooking vessel 601, in some embodiments a cooking vessel 601 can (e.g., integrally) comprise one or more coils and such a cooking vessel 601 can be coupled with a base portion 610 via a connection 680 or can be plugged into a base portion 610 (e.g., via a connection 680). In some embodiments, such a cooking vessel 601 with one or more coils can be a curved cooking vessel 601 or can be a flat cooking vessel 601 such as a heating pad, griddle, paella pan, frying pan, skillet, crepe pan, Teppanyaki grill, pizza grille, comal, tawa, or the like.

In some embodiments, such inductive heating can occur automatically when the stove coil 690 is turned on. However, in some embodiments, the inductive heating adapter 600 can comprise a switch, or the like, that can control current to the connection 680, control current to the third coil 660, or the like. In some embodiments, the adapter portion 650 can comprise a sensor that detects whether a cooking vessel 601 is suitably present in the cavity 652 of the adapter portion 650 (e.g., a physical button that the cooking vessel 601 depresses, or a suitable cooking vessel sensor such as an inductive sensor, capacitive sensor, infrared sensor, hall effect sensor, weight or pressure sensor, or the like) and prevents current to the third coil 660 or connection 680 if a cooking vessel 601 is determined to not be suitably present in the cavity 652 of the adapter portion 650.

Turning to FIGS. 1 and 2, in some embodiments, ferrites (e.g., first, second or third ferrites 622, 632, 662) can be ceramic elements comprising of iron oxide (Fe₂O₃) combined with other metals, such as nickel, zinc, or manganese oxides. Although ferrites of some examples can be related to ceramic materials with ferromagnetic properties, in some embodiments, ferrites may include any suitable composition that improves the effectiveness of induction, or the like. For example, in some embodiments, one or more ferrites can include a malleable soft magnet (e.g., malleable soft ferromagnet), which in some embodiments can enable the third coil 116 to be compliant, telescoping, configurable, or the like as discussed herein.

In various examples, ferrites can possess electromagnetic properties that are desirable in various embodiments discussed herein including induction heating applications, and the like. For example, ferrites can have high magnetic permeability, which can mean that ferrites can easily become magnetized in the presence of a magnetic field, which can help in concentrating and guiding a magnetic flux generated by an induction coil. In another example, ferrites can have low electrical conductivity, which can help to contain and guide a magnetic field while minimizing eddy currents within an associated coil. Eddy currents can cause energy losses and reduce the efficiency of the induction heating process, so using ferrites in some examples can help to mitigate these losses. In another example, ferrites can have heat resistance, which can allow such ferrites to withstand high temperatures generated by induction coils during cooking and prevent physical breaking of the ferrites or loss or reduction of the properties discussed above when exposed to heat.

In the context of inductive stove coils 690 and other coils discussed herein (e.g., coils 620, 630, 660), ferrites can be used as core materials within and/or about the winding of such coils. Such ferrites can help to shape and concentrate the magnetic field generated by a coil, directing it toward one or more desired element such as another coil, a cooking vessel 601, or the like. In some embodiments, a third ferrite 662 associated with a third coil 660 can enhance the efficiency of energy transfer from the third coil 660 to a cooking vessel 601 by focusing or concentrating a magnetic flux generated by the third coil 660 and reducing energy losses within the third coil 660. Similarly, in some embodiments, first and/or second ferrites 622, 632 can enhance the efficiency of energy transfer associated with the base unit 610 (e.g., energy transfer between and/or among a stove coil 690, first coil 620, and/or second coil 630).

Accordingly, by incorporating ferrites or ferrite materials into an inducting heating adapter 600 (e.g., associated with one or more coils), performance, efficiency, and reliability of the inducting heating adapter 600 can be improved while ensuring safety and durability even under high-temperature cooking conditions. However, in some embodiments, some or all ferrites discussed herein can be fully or partially absent in some embodiments, so the specific examples herein should not be construed as limiting.

For example, FIG. 7 illustrates an example embodiment where first, second and third coils 620, 630, 660 are respectively associated with first, second and third ferrites 622, 632, 662. In this example, the ferrites 622, 632, 662 extend radially from a center of the respective coil 620, 630, 660 with this example showing ferrites 622, 632, 662 with four elongated rectangular arms in a cross configuration at equal angles from each other (i.e., 90 degrees). However, further embodiments can include any suitable number of such radial arms disposed at the same or different angles from each other, including 2, 3, 4, 5, 6, 7, 8, 9, 10, 12, 16, 18, 24, 48, 96, or the like or a range between such example values. However, as discussed herein, one or more of such first, second and third ferrites 622, 632, 662 can be absent or ferrites can be present in other suitable shapes or configurations.

In various embodiments, a desirable, suitable or optimal distance between an induction coil and the bottom of a cooking vessel 601 for efficient heating can depend on the design and power of the induction coil, as well as the properties of the cooking vessel 601 being used. For example, as discussed herein, inductive heating can work through magnetic induction, where the magnetic field generated by a coil induces eddy currents in (e.g., ferrous) material of the cooking vessel 601. The closer the cooking vessel 601 is to the coil, the more effective the transfer of energy can be in various examples and the more efficient the heating process.

If the cooking vessel 601 is too far away from the coil, the magnetic field might not induce sufficient eddy currents in the cookware, resulting in slower or inefficient heating in various examples. On the other hand, if the cooking vessel 601 is too close to the coil, it can lead to issues such as overheating of the coil itself or potential damage to electronics or other systems associate with the coil due to excessive heat transfer. Additionally, having the cooking vessel 601 too close in some examples can disrupt the optimal functioning of the safety features, which may detect the proximity of the cooking vessel 601 as a fault or safety hazard.

In some embodiments, such an optimal, suitable or desirable distance between a coil and a cooking vessel 601 can be 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, or the like or a range between such example values. In one preferred embodiment, an optimal, suitable or desirable distance is between 1 mm and 5 mm.

Generating a consistent distance between a planar coil and a cooking vessel 601 with a planar base can be fairly simple; however, for cooking vessels 601 with a substantially curved base (e.g., a wok), a planar coil, stove top 126 or burner area 127 can result in a substantial base surface area or percentage of base surface area not being within an optimal, suitable or desirable distance such that a substantial base surface area or percentage of base surface of the cooking vessel 601 is inadequately heated or unheated, which can be undesirable for cooking.

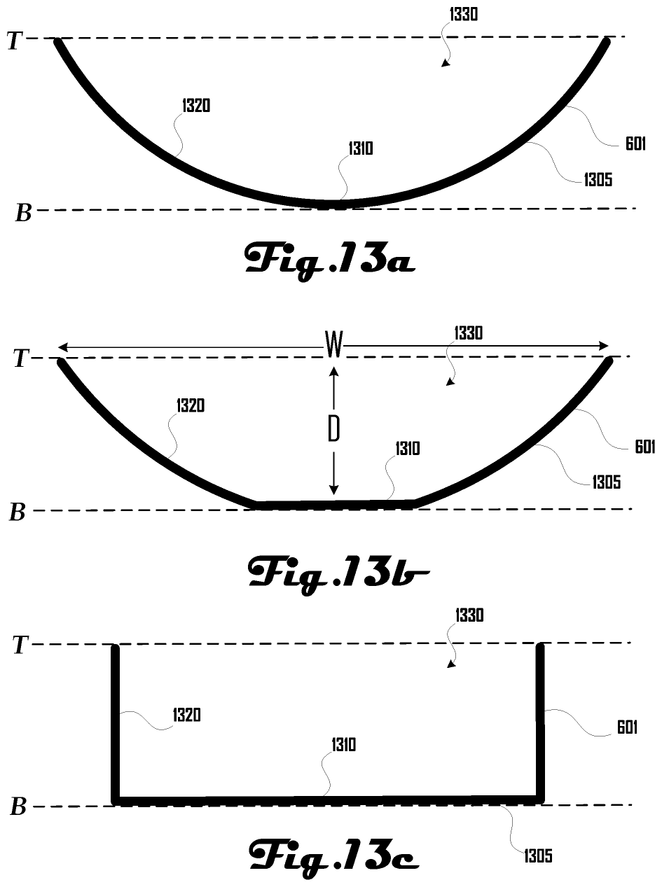

In various embodiments, cooking vessels 601 can have circular radial symmetry with a completely curved base or with a flat portion and a curved portion or a flat base with vertical sidewalls, or the like. For example, FIG. 13a illustrates an example of a cooking vessel 601 that comprises a completely and continuously curving base 1305 that includes a base minimum 1310 that is a point or small area with curved sidewalls 1320 extending therefrom. FIG. 13b illustrates an example of a cooking vessel 601 that comprises a partially curving base 1305 that includes a base minimum 1310 that is a planar area with curved sidewalls 1320 extending therefrom. FIG. 13c illustrates an example of a cooking vessel 601 that comprises a flat base 1305 that includes a base minimum 1310 that is a planar area with vertical sidewalls 1320 extending therefrom. In the examples of FIGS. 13a, 13b and 13c, the cooking vessels can have a base plane or axis B and a top plane or axis T and the base 1305 can define a cooking cavity 1330 at least in part. These examples should not be construed as limiting and the sidewalls 1320 can be linear, elliptical arc, circular arc, parabolic, or other suitable regular or irregular curve, slope, or the like.

As discussed herein, an adapter portion 650 of an inductive heating adapter 600 (e.g., a third coil 660 and/or a third ferrite 662) can be configured to define a cavity 652 having suitable shapes such as the shapes discussed above, which may or may not directly match or correspond to the full base 1305 or a portion of the base 1305 of one or more cooking vessel 601.

In various embodiments, an adapter portion 650 can be configured to create an optimal, suitable or desirable operating distance between a third coil 660 and base 1305 of a cooking vessel 601 (e.g., between 1 mm and 5 mm) over an amount or percentage of the surface area of the base 1305 of a cooking vessel 601. For example, in some embodiments, an adapter portion 650 can be configured to create an optimal, suitable or desirable distance between a third coil 660 and base 1305 of a cooking vessel 601 of at least 10, 15, 20, 25, 50, 75, 100, 200, 300, 400, 500, 600, 700, 800, 900, 1000, 1100, 1200 square inches, or the like, or a range between such example values. For example, in some embodiments, an adapter portion 650 can be configured to create an optimal, suitable or desirable distance between a third coil 660 and base 1305 of a cooking vessel 601 of at least 50%, 55%, 60%, 65%, 70%, 75%, 80%, 85%, 90%, 95%, 96%, 97%, 98%, 99% of the base 1305, or the like or a range between such example values.

In various embodiments, the cavity 652 of the adapter portion 650 can be concave and can have circular radial symmetry with a depth defined by the distance between a base minimum and top edges of the adapter portion 650 that defines the cavity 652 (see e.g., cooking vessel 601 illustrated in FIG. 13b, which illustrates analogous depth D and width W). For example, in some embodiments the depth of the cavity 652 can be greater than or equal to 0.5 inches, 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, or the like or a range between such example values. In some embodiments the width of the cavity 652 can be greater than or equal to 4 inches, 5 inches, 6 inches, 7 inches, 8 inches, 9 inches, 10 inches, 11 inches, 12 inches, 13 inches, 14 inches, 15 inches, 16 inches, 18 inches, 20 inches, 24 inches, 30 inches, 36 inches, 42 inches, 48 inches, or the like or a range between such example values.

In some embodiments, the adapter portion 650 and/or third coil 660 can be configured to change shape and/or size. In some embodiments, the adapter portion 650 and/or third coil 660 can be adjustable, such that the shape of the adapter portion 650 can adjust to different curved cooking vessels or to a planar cooking vessel. For example, in some such embodiments, the third coil 660 can be telescoping such that the height of along the length of the radius of the third coil can be raised and lowered to adapt to different shapes, profiles and/or sizes of cooking vessels 601. For example, a telescoping third coil 660 can be configured to adapt to shapes, profiles and/or sizes of cooking vessels 601 as show in FIGS. 13a, 13b and 13c including cooking vessels 601 of different diameters; cooking vessels 601 with and without a flat planar portion defining a base minimum 1310; different diameters of a flat planar portion defining a base minimum 1310; sidewalls 1320 with different lengths; sidewalls of different slopes and/or curves; slope or curves that are steep or gentle; and the like.

For example, in one example, the third coil 660 may be able to increase or decrease its curvature by 30%. In some embodiments, the third coil 660 can be configured to increase and/or decrease curvature by at least 20%, 30%, 40%, 50%, 60%, 70%, 80%, 90%, or the like or a range between such example values. In some embodiments, the third coil 660 can be configured to have a maximum change height (e.g., at the edges of a telescoping third coil 660 of at least 0.5 inches, 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, or the like or a range between such example values). In some embodiments, the width of the third coil 660 can be expanded.

In some embodiments, the adapter portion 650 and/or third coil 660 can be detachable (e.g., via the 680 connection) such that different adapter portions 650 and/or third coils 660 can be coupled with a 610 base portion, which may be desirable to allow different shapes, sizes and configurations of adapter portions 650 and/or third coils 660 to be equipped based on the cooking vessel 601 being used.

Also, while various embodiments of cooking vessels 610 and an adapter portion 650 can have circular radial symmetry, further embodiments can have various suitable shapes such as a rectangular regular prism, trapezoidal regular prism, hemispherical regular prism, conical, cylindrical, or the like. Accordingly, the examples shown and discussed herein should not be construed as being limiting.

Similarly, while various embodiments discussed herein relate to coils having (e.g., generally) circular radial symmetry (e.g., FIG. 2), including flat or pancake coils along with coils that define a cavity 652, coils can define various other suitable shapes, including planar shapes (e.g., square or rectangle) or three-dimensional shapes as discussed herein. Also, while some examples can include an adapter portion 650 with a single coil (e.g., third coil 660), further embodiments can include an adapter portion 650 with a plurality of coils. For example, a first central adapter portion coil can be planar and configured to correspond to a cooking vessel 601 having a planar base minimum 1310 and at least a second peripheral adapter portion coil configured to correspond to curved, sloped, or vertical sidewalls 1320 of the cooking vessel 601.

Also, while some embodiments can include pairs of planar coils disposed in adjacent separate parallel planes, in further embodiments, any other suitable arrangement of coils can be used, including nested coils, bifilar coils, or the like. Also in various embodiments, adjacent coils can be wound in the same direction (e.g., both clockwise or both counterclockwise) or can be in opposing directions (e.g., one clockwise and one counterclockwise). Also, coils discussed herein can be made of various suitable materials and have various suitable configurations such as comprising copper, aluminum, ferrite, silver, or the like. In some embodiments, a coil can comprise a Litz wire such as a wire composed of multiple individually insulated strands twisted or woven together. Coils can include various suitable structure or elements such as a core material, coil wire, insulation, sheath, casing, and the like. Such coils and materials can be configured for heat resistance for desirable electromagnetic properties or the like. Some or all coils of an inductive heating adapter 600 can have the same or different structures, compositions or materials.

In various embodiments, a first coil 620 can be a flat planar coil such that it can be set on one or more flat burner area 127 of a stove top 126 of an inductive stove 125. In various embodiments, the first coil 620 can function to receive energy from an inductive stove coil 690 and inductively transfer that heat energy to the second coil 630. The second coil 630 in various embodiments can be shaped complementary to the first coil 620, such that the second coil 630 can be positioned or disposed in proximity of the first coil 620 to enable inductive energy exchange therebetween. In various embodiments, the second coil 630 can be a flat planar coil with approximately the same size as the first coil 620.

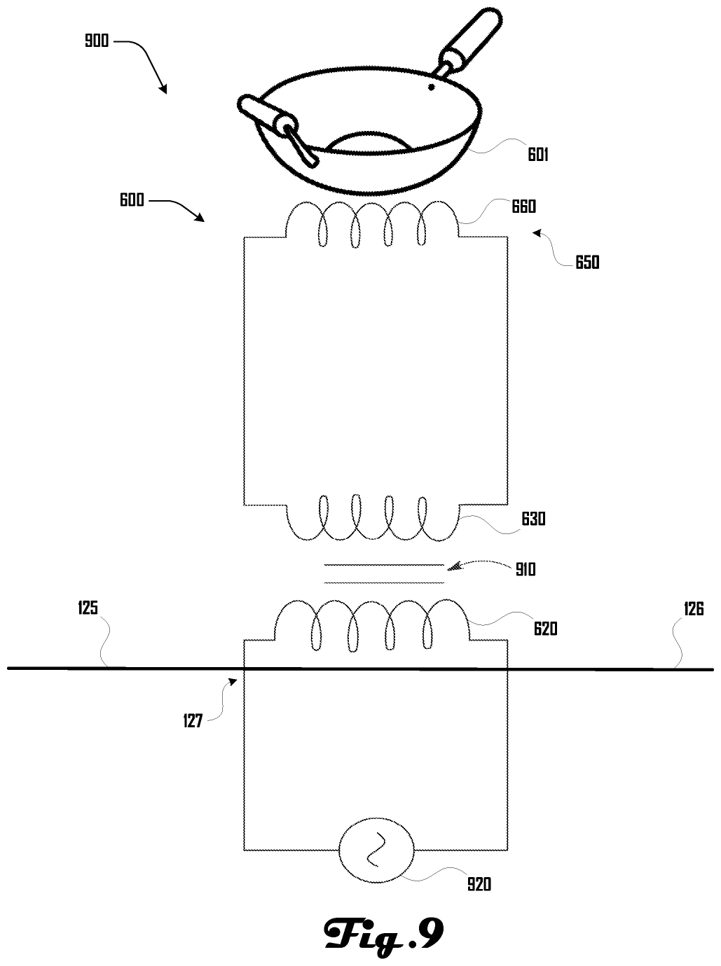

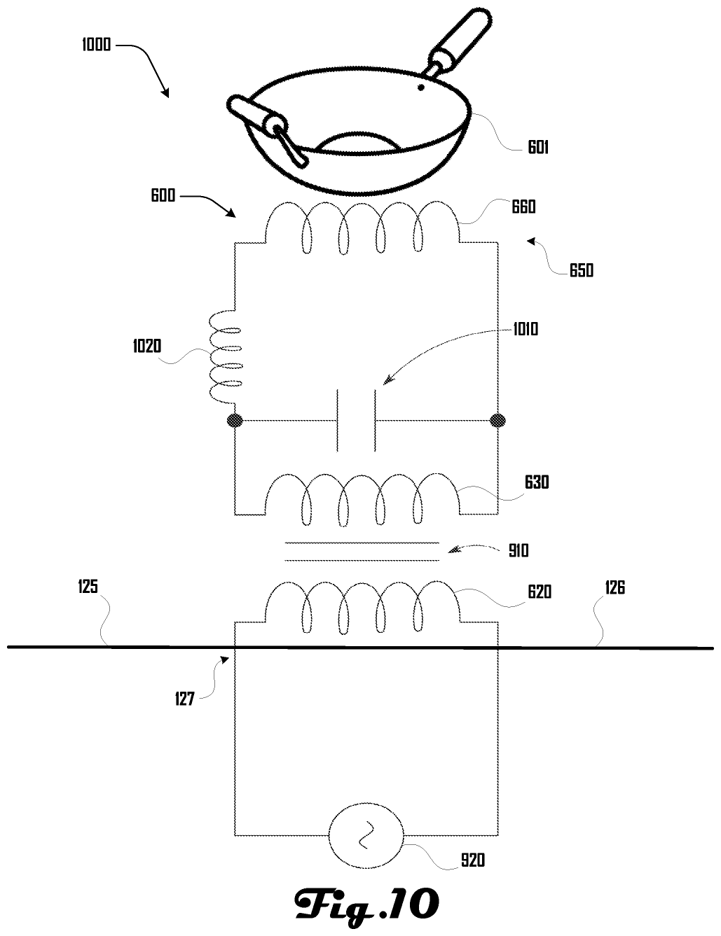

For wireless power transfer between the first coil 620 and the second coil 630, it can be desirable for impedance of driving circuitry of the first coil 620 to be matched to the second coil 630. This can be done in various suitable ways, including as illustrated by the electrical schematic 900 as shown in FIG. 9 which includes a first and second coil 620, 630 with a ferrite 910 therebetween. The first coil 620 can obtain power (e.g., wirelessly via power connection with a stove coil 690 as shown in FIG. 6) from a power source 920 of a stove 125 (e.g., about 60V, 30 kHz). In various embodiments, such as shown in the diagram 1000 of FIG. 10, an inductive heating adapter 600 can comprise a matching capacitor 1010 and/or matching inductor 1020 for matching impedance.

In some embodiments, the inductive heating adapter 600 can have a connection 680 such as one or more wire, which in various examples functions to electrically connect components such as the base portion 610 and adapter portion 650. In some embodiments, the second coil 630 and the third coil 660 are electrically connected by one or more connection 680. In some embodiments, the inductive heating adapter 600 can have any suitable number of connections 680 such as 1, 2, 3, 4, 5, 6, 7, 8, 9, 10, 15, 20, 25 or the like or a range between such example values. For example, in embodiments where the inductive heating adapter 600 has a burner fitting coil as discussed herein, the inductive heating adapter 600 may include an additional connection 680 that connects the burning fitting coil to one or more other coil of the inductive heating adapter 600 (e.g., to the first coil 620).

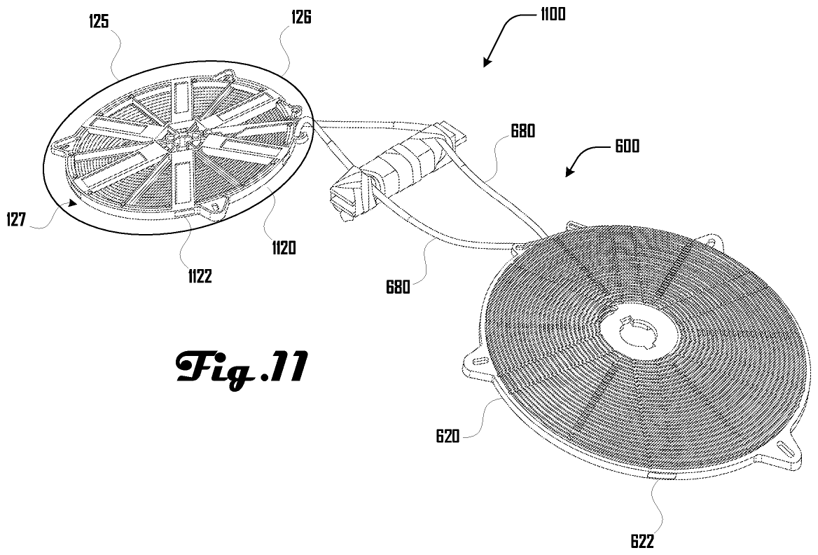

In some embodiments, an inductive heating adapter 600 can have additional coils or coils in different configurations or locations. As shown in the example embodiment 1100 of FIG. 11, an extension coil 1120 can be electrically coupled to a first coil 620 via one or more connections 680 (e.g., wires). For example, the first coil 620 of the inductive heating adapter 600 can be of an incorrect size such that the first coil 620 does not fit or is otherwise incompatible with a desired inductive stove burner area 127 of a stove 125 (e.g., the first coil 620 may be too small). In some such examples, the inductive heating adapter 600 can include an extension coil 1120, (e.g., a burner fitting coil), that is connected to the first coil 620 via one or more connections 680. In some such embodiments, the extension coil 1120 may sit on the burner area 127 of the stove top 126 of the stove 125 and have an electrical attachment to the first coil 620, with the first coil 620 not positioned on a burner area 127 of the stove top 126 of the stove 125. The extension coil 1120 may or may not include ferrites 1122.

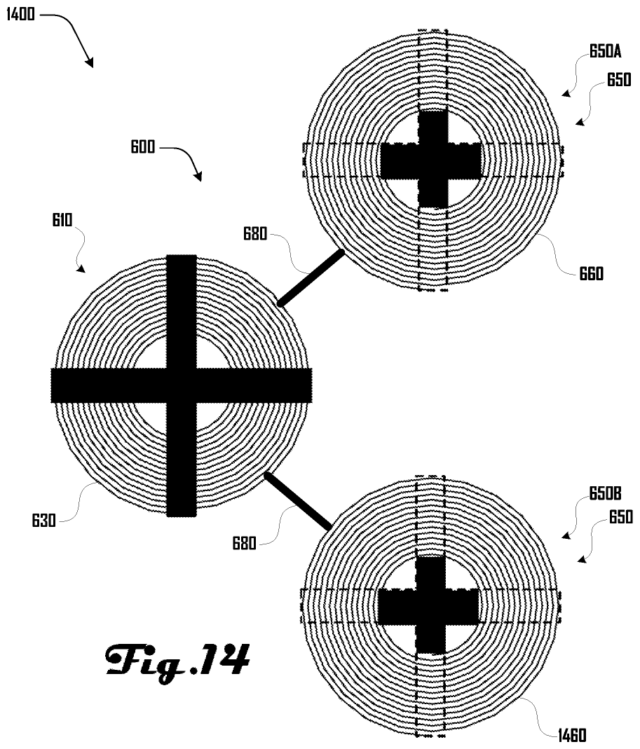

In another embodiment 1400, such as shown in FIG. 14, a base portion 610 of an inductive heating adapter 600 can be configured to power to a plurality of adapter portions 650 via respective couplings 680 (e.g., via separate wires, a split wire, or the like). For example, a first adapter portion 650A can comprise a third coil 660 as discussed herein and a second adapter portion can comprise a fourth coil 1460 (e.g., a second third coil 660). As discussed herein, the third and fourth coils 660, 1460 of the first and second adapter portions 650A, 650B can be configured to inductively heat a respective first and second cooking vessel 601 (not shown in FIG. 14). However, in some embodiments, the third and fourth coils 660, 1460 of the first and second adapter portions 650A, 650B can be configured to inductively heat separate portions of a single cooking vessel 601 (not shown in FIG. 14). Additionally, in some embodiments, a single adapter portion 650 can comprise a plurality of coils (e.g., third and fourth coils 660, 1460).

While the example of FIG. 14 illustrates two coils (i.e., the third and fourth coils 660, 1460) being powered by a single base portion 610, further embodiments can include any suitable plurality of coils powered by a single base portion 610, including 1, 2, 3, 4, 5, 6, 7, 8, 9, 10, 15, 25, 50, 100, or the like or a range between such example values. Similarly, there can be any suitable number of separate adapter portions 650, which can include one or more coils, with the number of separate adapter portions 650, including 1, 2, 3, 4, 5, 6, 7, 8, 9, 10, 15, 25, 50, 100, or the like or a range between such example values. Also, a base portion 610 can be configured in various suitable ways and can include a first coil 620 (not shown in FIG. 14), on which a second coil 630 can be stacked, or other suitable configuration.

In some embodiments, one or more switches can be configured to turn on and off (individually or collectively), a plurality of separate adapter portions 650. In some embodiments, one or more resistance selector (e.g., resistor dial) can be configured to adjust an amount of energy being transferred (individually or collectively) to a plurality of separate adapter portions 660. For example, energy distributed to two separate adapter portions 650A, 650B may be set so the first adapter portion 650A can be used for high-heat cooking purposes, whereas the second adapter portion 650B can function to maintain a cooking vessel 601 on low heat for maintaining temperature of food, slow cooking, warming, or the like.

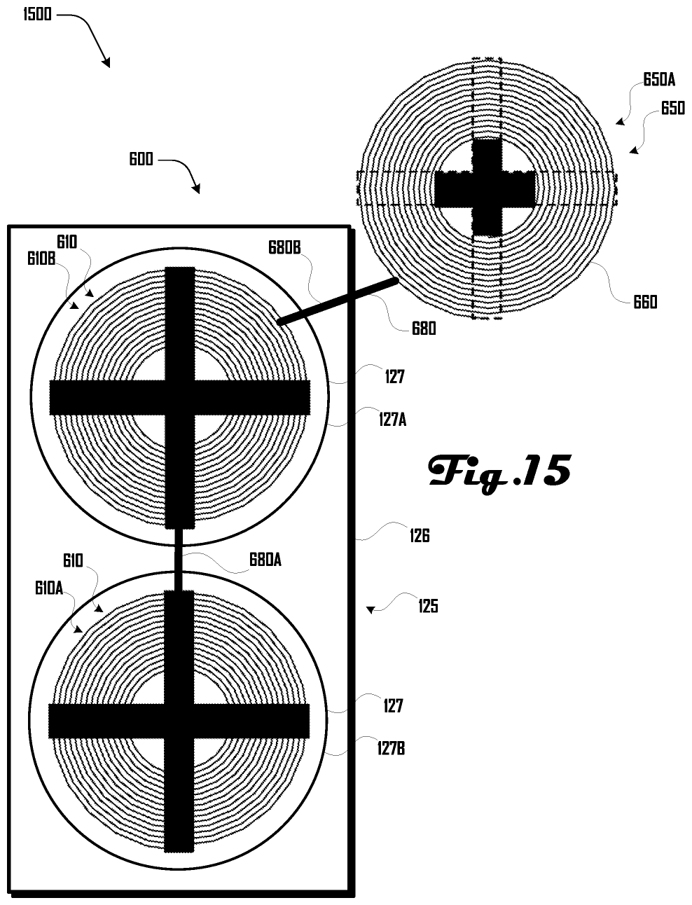

In some embodiments, a plurality of base portions 610 can provide power to a single adapter portion 650. For example, FIG. 15 illustrates an example embodiment 1500 that comprises a first and second base portion 610A, 610B that are disposed on a respective first and second burner area 127A, 127B on a stove top 126 of a stove 125. The first and second base portions 610A, 610B can be electrically coupled via a first connection 680A and can be collectively used to power an adapter portion 650 via a second connection 680B.

While the example of FIG. 15 illustrates the first and second base portion 610A, 610B coupled to each other via a first connection 680A and a second connection 680B between the second base portion 610B and the adapter portion 650, in further embodiments, such elements can be suitably electrically coupled in various suitable ways, including connections 680 coming from both the first and second base portions 610A, 610B to the adapter portion 650. Also, the adapter portion 650 can be disposed in various suitable locations such as on top of one of the base portions 610 as discussed herein, adjacent to the stove 125, on the stove top 126 or the like.

While the example of FIG. 15 illustrates first and second base portions 610A, 610B powering a single adapter portion 650, further embodiments can include an adapter portion 650 powered by any suitable plurality of base portions 610, including 2, 3, 4, 5, 6, 7, 8, or the like or a range between such example values. Similarly, there can be any suitable number of separate adapter portions 650, which can include one or more coils, with the number of separate adapter portions 650, including 1, 2, 3, 4, 5, 6, 7, 8, 9, 10, 15, 25, 50, 100, or the like or a range between such example values. For example, in some embodiments a single adapter portion 650 can include a plurality of coils. Also, one or more base portion 610 can be configured in various suitable ways and can include a first coil 620 and/or a second coil 630, which can be stacked as discussed herein in some examples, or in other suitable configuration.

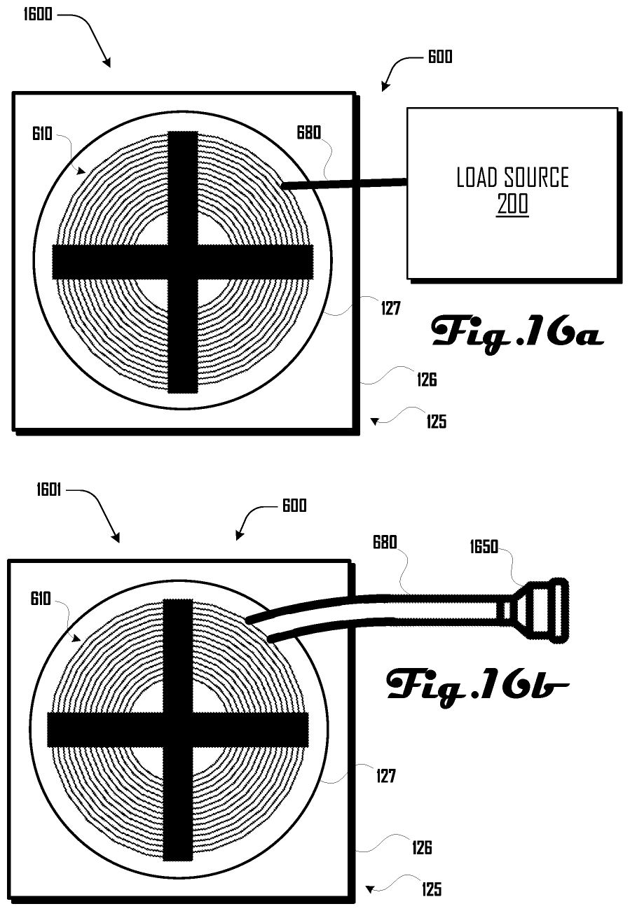

While various examples herein relate to an inductive heating adapter 600 having an adapter portion 650 for inductive heating of a cooking vessel 601, further embodiments can be configured to power any suitable type of appliance, device, machine, tool, instrument, apparatus, system, or the like. For example, FIG. 16a illustrates an example embodiment 6000 where a base portion 610 of an inductive heating adapter 600 is electrically coupled to a load source 200 via a connection 680. The base portion 610 can be configured to generate electrical current as discussed herein based on association with a burner area 127 on a stove top 126 of a stove 125. Accordingly, the stove 125 can be configured to power the load source 200 via the base portion 610 and connection 680.

Load source 200 in some embodiments can include a load source as shown and described in FIGS. 1 and 2, such as a heat pump 120, electric stove 125, refrigerator 130, electric vehicles 135, water heater 140, electrical floor heating elements 145, and the like. In some embodiments, such a load source 200 can include a kitchen appliance such as a dishwasher, microwave oven, toaster, blender, electric kettle, coffee maker, food processor, mixer, electric grill, slow cooker, rice cooker, juicer, stand mixer, electric can opener, bread maker, and the like. In some embodiments a load source 200 can include a television, computer, laptop, printer, scanner, Wi-Fi router, heater, fan, ventilation hood, vacuum cleaner, iron, hair dryer, electric toothbrush, electric shaver, sewing machine, electric drill, electric screwdriver, electric lawn mower, electric blanket, alarm clock, stereo system, game console, electric piano, treadmill, electric fireplace, or the like.

In various embodiments such as shown in FIG. 16b, the connection can comprise a suitable electrical plug 1650, which can allow the inductive heating adapter 600 to power any suitable appliance, device, machine, tool, instrument, apparatus, system, or the like, that can be plugged into the electrical plug 1650. The inductive heating adapter 600 can generate various suitable types of power, including 120V, 240V, and the like. Also, while some examples can include a single base portion 610, further embodiments can include any suitable number of base units 610 electrically coupled in various suitable ways and arrangements as discussed herein. Similarly, such one or more base units 610 can be configured to power any suitable plurality of load sources 200, appliances, devices, machines, tools, instruments, apparatuses, systems, or the like. In various embodiments, the electrical plug 1650 can comprise or be associated with an inverter.

Such an electrical plug 1650 can be a male or female plug in some embodiments (e.g., NEMA 5-15 P, NEMA 5-15R, or the like), which in some examples can allow a stove 125 to obtain electrical power from an external source via an inductive heating adapter 600. For example, in some embodiments, an electrical plug 1650 can be plugged into a receptacle 165 (see e.g., FIGS. 1, 3a, 3b and 3c), which may be part of or associated with a power distribution system 150, load source 200, battery 305, or the like. The inductive heating adapter 600 receives electrical power via the plug 1650 of the connection 680 and the base unit 610 can wirelessly inductively transfer power to a stove coil 690 when the base unit is disposed on a burner area 127 on a stove top 126 of a stove 125. In various embodiments, this can work in the reverse of how the stove coil 690 wirelessly inductively transfers power to the base unit 610.

In various embodiments, electrical power obtained by the stove 125 can be stored in a battery 305 of the stove 125, can be used to power the stove 125 (e.g., an oven, one or more stove coils 690, battery system 305, or the like), or be used to power other devices, appliances or load sources 200 that may be electrically connected to the stove 125 (e.g., via a receptacle 165 of the stove, inductive heating adapter 600, or the like). In some embodiments, a stove 125 can be partially or completely operated via power obtained via an inductive heating adapter 600 such that the stove 125 need not be plugged into a receptacle 135 to fully or partially operate.

In various embodiments, one or more inductive heating adapters 600 can be configured to receive and/or send electrical power within a system such as shown and described in FIGS. 1, 3a, 3b, 3c, or the like. For example, one or more inductive heating adapters 600 can allow a stove 125 to be part of a powered building system 100 as discussed herein, including smart sharing, using and/or storing of electrical power among one or more other load sources 200, batteries 305, or the like.

In various embodiments, an inductive heating adapter 600 can be any suitable complex or simple system. For example, in some embodiments, an inductive heating adapter 600 can include one or more elements of a battery system 300 as shown and described in FIG. 4, such as one or more batteries 305, a processor 410, a memory 420, a clock 430, a battery control system 440, a communication system 450, an interface 460 and an electrical power bus 470. However, in some embodiments, such elements can be specifically absent and the inductive heating adapter 600 can be a simple passive non-electronic device.

In some embodiments, a stove 125 can be configured to identify an inductive heating adapter 600 present on a given a burner area 127 on a stove top 126 of a stove 125, which in some examples can include simply identifying whether an inductive heating adapter 600 is present or not present; a type of an inductive heating adapter 600 (e.g., based on a model, or identified characteristics of an inductive heating adapter 600); a unique identifier (e.g., MAC address, or the like). In some embodiments, operation of the stove 125 can be configured based on such identified information about the presence, identity or characteristics of the inductive heating adapter 600. For example, a stove 125 can identify one or more characteristics or identity of an inductive heating adapter 600 and can cause a stove coil 690 at the burner area 127 where the inductive heating adapter 600 is disposed to select and generate a waveform that is suitable for the characteristic(s) or identity of the heating adapter 600.

For example, a method can include a stove 125 (e.g., battery system 300) determining characteristic or identity of an inductive heating adapter 600 disposed at a burner area 127 of a stove top 126; determining a suitable inductive waveform based at least in part on the determined characteristic or identity of the inductive heating adapter 600; and causing a stove coil 690 to generate the determined waveform that causes inductive heating of a cooking vessel 601 disposed in the inductive heating adapter 600. The presence, identity or characteristics of an inductive heating adapter 600 can be determined in various suitable ways, including via an RFID tag associated with the inductive heating adapter 600; a resistor with a value; or communication of information wirelessly such as via Near Field Communication (NFC), Bluetooth, Wi-Fi, or the like. In some embodiments, a stove 125 can have four burner areas 127 configured to each identify presence, identity or characteristic(s) of an inductive heating adapter 600 at the respective burner area 127.

In some embodiments, it may be desirable to cool an inductive heating adapter 600 during operation (e.g., to cool one or more coils). For example, FIG. 12 illustrates and example embodiment 1200 that includes a fan 1220 and/or other suitable thermal control elements. In various embodiments, power for such elements can be obtained from one or more coils of the inductive heating adapter 600, which can include power obtained from an inductor circuit (e.g., a set of coils) via a bridge rectifier and/or current limiter.

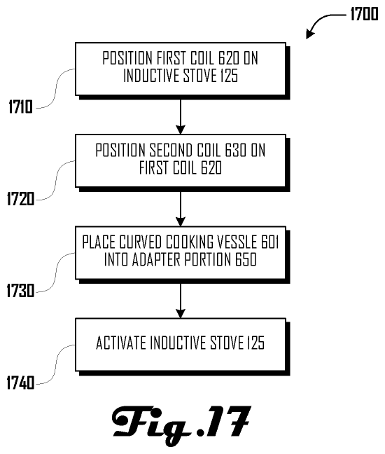

Turning to FIG. 17, a method 1700 of using an embodiment of an inductive stove adapter 600 is illustrated. The method 1700 begins, at 1710, where a first coil 620 is positioned on an inductive stove 125, and at 1720, a second coil 630 is positioned on the first coil 620, which in various embodiments enables induction between the first and second coils 620, 630.

At 1730, a cooking vessel 601 is placed into an adapter portion 650 of the inductive stove adapter 600. In various embodiments, the adapter portion 650 comprises an adapter coil 660 that is electrically connected to the second coil 630 via a connection 680. The method 1700 continues to 1740 where the induction stove 125 is activated, which can cause a stove coil 690 to generate an electrical current via the first and second coils 620, 630 that powers the adapter coil 660 to cause inductive heating of the cooking vessel 601 disposed in the adapter portion 650.

In various embodiments, such a method 1700 can enable utilization of an inductive stove adapter 600 to heat a curved cooking vessel 601 (e.g., a wok) with an inductive stove 125. The method 1700 may be implemented with various suitable inductive stove adapters 600, including at least one inductive stove adapter 600 discussed herein.

Positioning a first coil 620 onto an inductive stove 125, at 1710, can function to enable energy transfer from the inductive stove 125 to the inductive stove adapter 600. This can require in some embodiments positioning the first coil 620 onto a burner area 127 of a stove top 126 and sufficiently proximate to a stove coil 690 at the burner area 127. If the size of the first coil 620 does not sufficiently match the size of the stove coil at the burner area 127, an additional adapter may be necessary in some examples.

Positioning a second coil 630 in proximity of the first coil 620, at 1720, can function to enable energy transfer between the first coil 620 and the second coil 630. In various embodiments, the second coil 630 can be placed/positioned on top of the first coil 620. In some embodiments, there can be a locking/connecting mechanism such that the second coil 630 “locks” in place onto the first coil 620. Additionally, or alternatively, in some examples the first coil 620 and second coil 630 can have complementary grooves, such that the second coil 630 may be set in a unique manner to guarantee that the second coil 630 is in sufficient proximity to enable induction between the first and second coils 620, 630.

Placing an applicable curved cooking vessel 601 onto an adapter portion 650, at 1730, can function to place the cooking vessel 601 to be heated onto the inductive heating adapter 600 in a manner that energy transfer may occur through induction between a third coil 660 of the adapter portion 650 and the applicable cooking vessel 601. As the third coil 660 can be directly connected to the second coil 630 via a connection 680, correct positioning of the curved cooking vessel 601 can enable heating the cooking vessel 601, and thus contents of the cooking vessel 601, by control of the inductive stove 125. In some embodiments, the curved cooking vessel 601 can be unique such that the shape of the third coil 660 and/or adapter portion 650 specifically fits the shape of the cooking vessel 601. In some embodiments, the third coil 660 and/or adapter portion 650 can be compliant and the shape of the third coil 660 and/or adapter portion 650 be modified to enable suitable coupling with the cooking vessel 601 such that the cooking vessel 601 is sufficiently inductively heated as discussed herein (e.g., based on a suitable distance between the third coil 660 and the cooking vessel 601).

Activating the inductive stove, at 1740, can function to provide heating to the curved cooking vessel 601. Once components of the inductive heating adapter 600 and the cooking vessel are positioned correctly or suitably, activating the inductive stove 125 can provide the desired type of cooking, or any other type of heating as desired, via the cooking vessel 601.

As used herein, terms like first, second, third, fourth, etc., are used to characterize and distinguish various elements, components, regions, layers and/or sections. These elements, components, regions, layers and/or sections should not be construed to be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeably without departing from the teaching of the embodiments and variations herein. Moreover, numerical terms should not be used to imply that specific elements are required in some embodiments. For example, some embodiments can include a first and third coil 620, 660 with a second coil 630 being absent. In some embodiments, a second and third coil 630, 660 can be present without a first coil 620 being present.

Some embodiments can include a system for a wireless power transmission inductive heating adapter that includes: a set of coils, that includes a first coil, flat and forming the bottom surface of the adapter, a second coil, flat and situated above the first coil, and a third coil, with a curved form factor shape; an optional set of ferrites that includes: a first ferrite, situated adjacent and underneath the first coil, a second ferrite, situated adjacent and above the second coil, and a third ferrite situated underneath and adjacent to the third coil; and an electrical junction, electrically connecting the second coil to the third coil.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. An inductive heating adapter, the inductive heating adapter comprising:
a base portion that includes:
a planar first coil
a planar second coil
a first ferrite defined by a first plurality of at least four elongated rectangular arms extending radially from a center of the planar first coil, the first plurality of at least four elongated rectangular arms disposed within a common plane and at the same angle from each other, and
a second ferrite defined by a second plurality of at least four elongated rectangular arms extending radially from a center of the planar second coil, the second plurality of at least four elongated rectangular arms disposed within a common plane and at the same angle from each other,
the planar first coil, planar second coil, first ferrite and second ferrite disposed in a stacked configuration with the planar second coil disposed on top of and directly adjacent to the planar first coil, the second ferrite disposed on top of and directly adjacent to the planar second coil and the first ferrite disposed under and directly adjacent to the planar first coil;
an adapter portion that defines a concave curved cavity having circular radial symmetry with a maximum diameter of at least 6 inches and a maximum depth of at least 3 inches, the adapter portion comprising a curved third coil and a curved third ferrite that correspond to the concave curved cavity, the adapter portion configured to create a suitable operating distance of within 1 mm-5 mm between the curved third coil and a base of a curved cooking vessel over at least 50 square inches of the surface area of the base of the curved cooking vessel and at least 60% of the surface area of the base of the curved cooking vessel disposed within the concave curved cavity defined by the adapter portion; and
an electrical connection between the planar second coil and the curved third coil, the electrical connection comprising a wire configured to convey electrical current generated by the planar second coil to the curved third coil,
wherein the base portion has a flat bottom configured to be disposed on a planar burner area of a planar stove top of an inductive stove with the curved cooking vessel disposed within the concave curved cavity defined by the adapter portion, and
wherein the planar burner area of the inductive stove comprises a stove coil disposed below and within the planar stove top, the stove coil configured to inductively and wirelessly generate an electrical current in the base portion, where the planar first coil and the planar second coil of the base portion serve as intermediary wireless transformers to convey electrical to the curved third coil of the adapter portion via the electrical connection to cause inductive heating of the curved cooking vessel disposed within the concave curved cavity defined by the adapter portion to provide for cooking with the curved cooking vessel.

2. The inductive heating adapter of claim 1, wherein the curved cooking vessel is a wok.

3. The inductive heating adapter of claim 1, wherein the adapter portion is coupled above the base portion via a plurality of adapter arms such that respective centers of the planar first coil, the planar second coil, the curved third coil and a center of the concave curved cavity are disposed along a common axis.

4. The inductive heating adapter of claim 1, wherein the inductive heating adapter consists of:
the base portion,
the adapter portion, and
the electrical connection.

5. An inductive heating adapter, the inductive heating adapter comprising:
a base portion that includes:
a planar first coil
a planar second coil
a first ferrite, and
a second ferrite,
the planar first coil, planar second coil, first ferrite and second ferrite disposed in a stacked configuration with the planar second coil disposed on top of and directly adjacent to the planar first coil, the second ferrite disposed on top of and directly adjacent to the planar second coil and the first ferrite disposed under and directly adjacent to the planar first coil;
an adapter portion that defines a concave curved cavity having circular radial symmetry, the adapter portion comprising a curved third coil and a curved third ferrite that correspond to the concave curved cavity, the adapter portion configured to create a suitable operating distance between the curved third coil and a base of a curved cooking vessel disposed within the concave curved cavity defined by the adapter portion; and
an electrical connection between the planar second coil and the curved third coil, the electrical connection comprising a wire configured to convey electrical current generated by the planar second coil to the curved third coil,
wherein the base portion has a flat bottom configured to be disposed on a planar burner area of a planar stove top of an inductive stove with the curved cooking vessel disposed within the concave curved cavity defined by the adapter portion, and
wherein the planar burner area of the inductive stove comprises a stove coil disposed below and within the planar stove top, the stove coil configured to inductively and wirelessly generate an electrical current in the base portion, where the planar first coil and the planar second coil of the base portion serve as intermediary wireless transformers to convey electrical to the curved third coil of the adapter portion via the electrical connection to cause inductive heating of the curved cooking vessel disposed within the concave curved cavity defined by the adapter portion to provide for cooking with the curved cooking vessel.

6. The inductive heating adapter of claim 5, wherein the first ferrite is defined by a first plurality of at least four elongated rectangular arms extending radially from a center of the planar first coil, the first plurality of at least four elongated rectangular arms disposed within a common plane and at the same angle from each other, and
wherein the second ferrite is defined by a second plurality of at least four elongated rectangular arms extending radially from a center of the planar second coil, the second plurality of at least four elongated rectangular arms disposed within a common plane and at the same angle from each other.

7. The inductive heating adapter of claim 5, wherein the adapter portion that defines the concave curved cavity having the circular radial symmetry with a maximum diameter of at least 6 inches and a maximum depth of at least 3 inches.

8. The inductive heating adapter of claim 5, wherein the suitable operating distance is within 1 mm-5 mm between the curved third coil and the base of the curved cooking vessel.

9. The inductive heating adapter of claim 5, wherein the suitable operating distance is over at least 50 square inches of the surface area of the base of the curved cooking vessel.

10. The inductive heating adapter of claim 5, wherein the suitable operating distance is over at least 60% of the surface area of the base of the curved cooking vessel.

11. An inductive heating adapter, the inductive heating adapter comprising:
a base portion that includes:
a planar first coil, and
a planar second coil
an adapter portion that defines a curved cavity, the adapter portion comprising a curved third coil that corresponds to the curved cavity, the adapter portion configured to hold a curved vessel within the curved cavity defined by the adapter portion; and
an electrical connection between the base portion and the adapter portion,
wherein the base portion is configured to be disposed on a burner area of a stove top of an inductive stove with the curved vessel disposed within the curved cavity defined by the adapter portion, and
wherein the burner area of the inductive stove comprises a stove coil configured to wirelessly generate an electrical current in the base portion that causes inductive heating of the curved vessel disposed within the curved cavity defined by the adapter portion.

12. The inductive heating adapter of claim 11, wherein the base portion further includes a first ferrite and a second ferrite.

13. The inductive heating adapter of claim 11, wherein the planar first coil and the planar second coil are disposed in a stacked configuration with the planar second coil disposed on top of and adjacent to the planar first coil.

14. The inductive heating adapter of claim 11, wherein the adapter portion defines the curved cavity having circular radial symmetry.

15. The inductive heating adapter of claim 11, wherein the adapter portion is configured to create a suitable operating distance between the curved third coil and a base of the curved vessel disposed within the curved cavity defined by the adapter portion.

16. The inductive heating adapter of claim 11, wherein the adapter portion comprises a curved third ferrite.

17. The inductive heating adapter of claim 11, wherein the electrical connection is between the planar second coil and the curved third coil.

18. The inductive heating adapter of claim 11, wherein the stove coil is configured to inductively and wirelessly generate an electrical current in the base portion, where the planar first coil and the planar second coil of the base portion serve as intermediary wireless transformers to convey electrical to the curved third coil of the adapter portion via the electrical connection to cause inductive heating of the curved vessel disposed within the curved cavity defined by the adapter portion.

19. The inductive heating adapter of claim 11, wherein the adapter portion that defines the curved cavity having circular radial symmetry with a maximum diameter of at least 6 inches and a maximum depth of at least 3 inches.

20. The inductive heating adapter of claim 11, wherein the adapter portion is coupled above the base portion such that respective centers of the planar first coil, the planar second coil, the curved third coil and a center of the curved cavity are disposed along a common axis.
